(19) United States
(12) Patent Application Publication
(10) Pub. No.: US 2014/0349732 A1
(43) Pub. Date: Nov. 27, 2014

(54) GAME INDEPENDENT OUTCOMES ON A GAMING DEVICE

(71) Applicants: Jason Pawloski, Decatur, GA (US); Steven Davis, Suwanee, GA (US)

(72) Inventors: Jason Pawloski, Decatur, GA (US); Steven Davis, Suwanee, GA (US)

(73) Assignee: CADILLAC JACK, DULUTH, GA (US)

(21) Appl. No.: 13/898,727

(22) Filed: May 21, 2013

(51) Int. Cl. G07F 17/34

(52) U.S. Cl. CPC G07F 17/34
USPC 463/20

(57) ABSTRACT

Examples disclosed herein relate to an electronic gaming device including a memory, a processor, and a plurality of reels. The plurality of reels may include one or more areas. The memory may include one or more independent features structures. The processor may generate one or more symbols to be located in the one or more areas. The processor may initiate at least a first independent feature structure based on an independent feature triggering event.

### FIELD

The subject matter disclosed herein relates to an electronic gaming device. More specifically, the disclosure relates to providing an outcome that is independent from game play on the electronic gaming device.

### INFORMATION

The gaming industry has numerous casinos located both worldwide and in the United States. A client of a casino or other gaming entity can gamble via various games of chance. For example, craps, roulette, baccarat, blackjack, and electronic games (e.g., a slot machine) where a person may gamble on an outcome.

Paylines of an electronic gaming device (e.g., a slot machine) are utilized to determine when predetermined winning symbol combinations are aligned in a predetermined pattern to form a winning combination. A winning event occurs when the player successfully matches the predetermined winning symbols in one of the predetermined patterns.

A player's entertainment while playing one or more games may be enhanced by utilizing an outcome that is independent from game play on the electronic gaming device. By increasing the player's entertainment level, the player's enjoyment of the game may be enhanced, which may increase a player's game playing period.

### BRIEF DESCRIPTION OF THE FIGURES

Non-limiting and non-exhaustive examples will be described with reference to the following figures, wherein like reference numerals refer to like parts throughout the various figures.

FIG. 1 is an illustration of the electronic gaming device, according to one embodiment.

FIG. 2 is an illustration of an electronic gaming system, according to one embodiment.

FIG. 3 is a block diagram of the electronic gaming device, according to one embodiment.

FIG. 4 is another block diagram of the electronic gaming device, according to one embodiment.

FIG. 5A is an illustration of game play on a gaming device, according to one embodiment.

FIG. 5B is another illustration of game play on a gaming device, according to one embodiment.

FIG. 5C is another illustration of game play on a gaming device, according to one embodiment.

FIG. 5D is another illustration of game play on a gaming device, according to one embodiment.

FIG. 5E is another illustration of game play on a gaming device, according to one embodiment.

FIG. 5F is another illustration of game play on a gaming device, according to one embodiment.

FIG. 5G is another illustration of game play on a gaming device, according to one embodiment.

FIG. 5H is another illustration of game play on a gaming device, according to one embodiment.

FIG. 5J is another illustration of game play on a gaming device, according to one embodiment.

FIG. 5K is another illustration of game play on a gaming device, according to one embodiment.

FIG. 5L is another illustration of game play on a gaming device, according to one embodiment.

FIG. 5M is another illustration of game play on a gaming device, according to one embodiment.

FIG. 5N is another illustration of game play on a gaming device, according to one embodiment.

FIG. 5P is another illustration of game play on a gaming device, according to one embodiment.

FIG. 5Q is another illustration of game play on a gaming device, according to one embodiment.

FIG. 5R is another illustration of game play on a gaming device, according to one embodiment.

FIG. 5S is another illustration of game play on a gaming device, according to one embodiment.

FIG. 5T is another illustration of game play on a gaming device, according to one embodiment.

FIG. 5U is another illustration of game play on a gaming device, according to one embodiment.

FIG. 5V is another illustration of game play on a gaming device, according to one embodiment.

FIG. 6A is another illustration of game play on a gaming device, according to one embodiment.

FIG. 6B is another illustration of game play on a gaming device, according to one embodiment.

FIG. 6C is another illustration of game play on a gaming device, according to one embodiment.

FIG. 6D is another illustration of game play on a gaming device, according to one embodiment.

FIG. 6E is another illustration of game play on a gaming device, according to one embodiment.

FIG. 6F is another illustration of game play on a gaming device, according to one embodiment.

FIG. 6G is another illustration of game play on a gaming device, according to one embodiment.

FIG. 7 is a game play flow diagram, according to one embodiment.

FIG. 8 is a flow diagram for game play, according to one embodiment.

FIG. 9 is a flow diagram for game play, according to one embodiment.

FIG. 10A is a flow diagram for game play, according to one embodiment.

FIG. 10B is a flow diagram for game play, according to one embodiment.

FIG. 11 is a flow diagram for game play, according to one embodiment.

FIG. 12A is a flow diagram for game play, according to one embodiment.

FIG. 12B is a flow diagram for game play, according to one embodiment.

FIG. 12C is a flow diagram for game play, according to one embodiment.

FIG. 13 is a flow diagram for game play, according to one embodiment.

### DETAILED DESCRIPTION

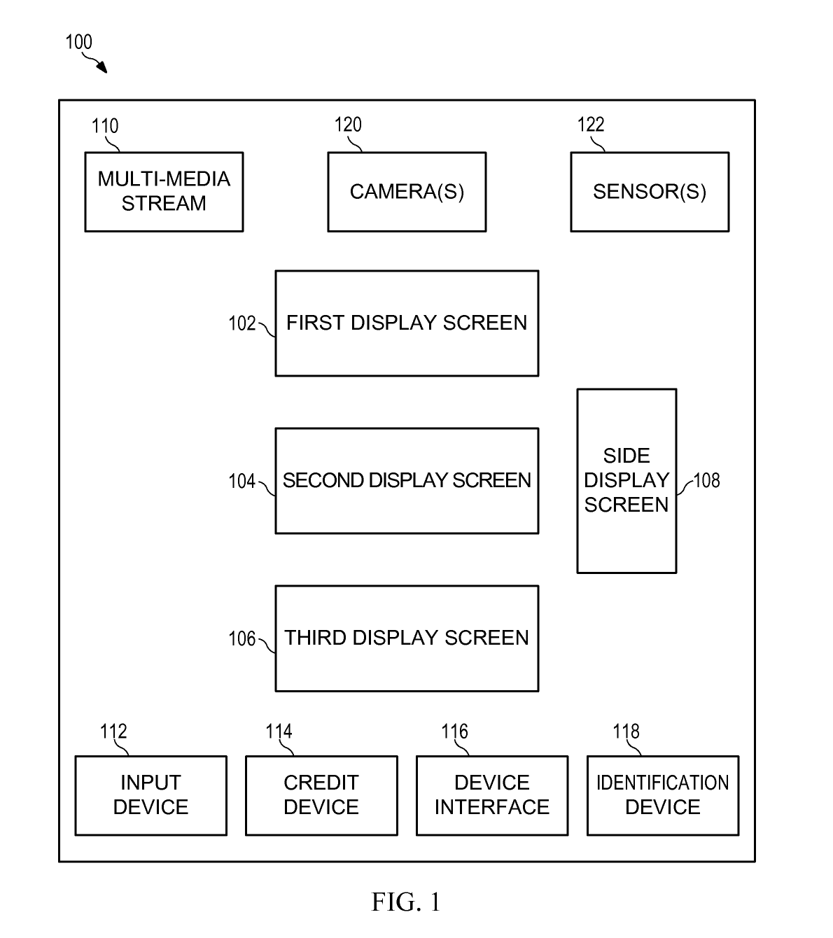

FIG. 1 is an illustration of an electronic gaming device 100. Electronic gaming device 100 may include a multi-media stream 110, a first display screen 102, a second display screen 104, a third display screen 106, a side display screen 108, an input device 112, a credit device 114, a device interface 116, and an identification device 118. Electronic gaming device 100 may display one, two, a few, or a plurality of multi-media streams 110, which may be obtained from one or more gaming tables, one or more electronic gaming devices, a central server, a video server, a music server, an advertising server, another data source, and/or any combination thereof.

Multi-media streams may be obtained for an entertainment event, a wagering event, a promotional event, a promotional offering, an advertisement, a sporting event, any other event, and/or any combination thereof. For example, the entertainment event may be a concert, a show, a television program, a movie, an Internet event, and/or any combination thereof. In another example, the wagering event may be a poker tournament, a horse race, a car race, and/or any combination thereof. The advertisement may be an advertisement for a casino, a restaurant, a shop, any other entity, and/or any combination thereof. The sporting event may be a football game, a baseball game, a hockey game, a basketball game, any other sporting event, and/or any combination thereof. These multi-media streams may be utilized in combination with the gaming table video streams.

Input device 112 may be mechanical buttons, electronic buttons, mechanical switches, electronic switches, optical switches, a slot pull handle, a keyboard, a keypad, a touch screen, a gesture screen, a joystick, a pointing device (e.g., a mouse), a virtual (on-screen) keyboard, a virtual (on-screen) keypad, biometric sensor, or any combination thereof. Input device 112 may be utilized to select one or more game independent options, to make a wager, to control any object, to select one or more pattern gaming options, to obtain data relating to historical payouts, to select a row and/or column to move, to select a row area to move, to select a column area to move, to select a symbol (or image) to move, to modify electronic gaming device 100 (e.g., change sound level, configuration, font, language, etc.), to select a movie or song, to select live multi-media streams, to request services (e.g., drinks, slot attendant, manager, etc.), to select two-dimensional (“2D”) game play, to select three-dimensional (“3D”) game play, to select both two-dimensional and three-dimensional game play, to change the orientation of games in a three-dimensional space, to move a symbol (e.g., wild, multiplier, etc.), and/or any combination thereof. These selections may occur via any other input device (e.g., a touch screen, voice commands, etc.). Input device 112 may be any control panel.

Credit device 114 may be utilized to collect monies and distribute monies (e.g., cash, vouchers, etc.). Credit device 114 may interface with a mobile device to electronically transmit money and/or credits. Credit device 114 may interface with a player's card to exchange player points.

Device interface 116 may be utilized to interface electronic gaming device 100 to a bonus game device, a local area progressive controller, a wide area progressive controller, a progressive sign controller, a peripheral display device, signage, a promotional device, network components, a local network, a wide area network, remote access equipment, a slot monitoring system, a slot player tracking system, the Internet, a server, and/or any combination thereof.

Device interface 116 may be utilized to connect a player to electronic gaming device 100 through a mobile device, card, keypad, identification device 118, and/or any combination thereof. Device interface 116 may include a docking station by which a mobile device is plugged into electronic gaming machine 100. Device interface 116 may include an over the air connection by which a mobile device is connected to electronic gaming machine 100 (e.g., Bluetooth, Near Field technology, and/or Wi-Fi technology). Device interface 116 may include a connection to identification device 118.

Identification device 118 may be utilized to determine an identity of a player. Based on information obtained by identification device 118, electronic gaming device 100 may be reconfigured. For example, the language, sound level, music, placement of multi-media streams, one or more game functionalities (e.g., game type 1, game type 2, game type 3, etc.) may be presented, a game independent gaming option may be presented, a repeat payline gaming option may be presented, a pattern gaming option may be presented, historical gaming data may be presented, a row rearrangement option may be presented, a column rearrangement option may be presented, a row area rearrangement option may be presented, a column area rearrangement option may be presented, a two-dimensional gaming option may be presented, a three-dimensional gaming option may be presented, and/or the placement of gaming options may be modified based on player preference data. For example, the player may only want to play games that include game independent gaming options only. Therefore, only games which include game independent gaming options would be presented to the player. In another example, the player may only want to play games that include historical information relating to game play. Therefore, only games which include historical gaming data would be presented to the player. These examples may be combined.

Identification device 118 may utilize biometrics (e.g., thumb print, retinal scan, or other biometric). Identification device 118 may include a card entry slot into input device 112. Identification device 118 may include a keypad with an assigned pin number for verification. Identification device 118 may include multiple layers of identification for added security. For example, a player could be required to enter a player tracking card, and/or a pin number, and/or a thumb print, and/or any combination thereof. Based on information obtained by identification device 118, electronic gaming device 100 may be reconfigured. For example, the language, sound level, music, placement of video streams, placement of images, and the placement of gaming options utilized may be modified based on a player's preference data. For example, a player may have selected baseball under the sporting event preferences; electronic gaming device 100 will then automatically display the current baseball game onto side display screen 108 and/or an alternate display screen as set in the player's options.

First display screen 102 may be a liquid crystal display (“LCD”), a cathode ray tube display (“CRT”), organic light-emitting diode display (“OLED”), plasma display panel (“PDP”), electroluminescent display (“ELD”), a light-emitting diode display (“LED”), or any other display technology. First display screen 102 may be used for displaying primary games or secondary (bonus) games, to display one or more warnings relating to one or more audio devices, one or more display devices, one or more electrical wires, one or more springs, one or more motors, one or more adjustable devices, and/or one or more sensors, advertising, player attractions, electronic gaming device 100 configuration parameters and settings, game history, accounting meters, events, alarms, and/or any combination thereof. Second display screen 104, third display screen 106, side display screen 108, and any other screens may utilize the same technology as first display screen 102 and/or any combination of technologies.

First display screen 102 may also be virtually combined with second display screen 104. Likewise second display screen 104 may also be virtually combined with third display screen 106. First display screen 102 may be virtually combined with both second display screen 104 and third display screen 106. Any combination thereof may be formed.

For example, a single large image could be partially displayed on second display screen 104 and partially displayed on third display screen 106, so that when both display screens are put together they complete one image. Electronic gaming device 100 may stream or play prerecorded multi-media data, which may be displayed on any display combination.

One or more cameras 120 and/or one or more sensors 122 may be utilized as one or more depth image sensing devices, which may be located in various locations, including but not limited to, above the base display, above second display, in one or more locations on gaming cabinet front, on a side of the gaming cabinet other than gaming cabinet front, and/or any other location.

In one embodiment, electronic gaming device 100 may not include separate one or more input devices, but instead may only utilize one or more depth image sensing devices. In another embodiment, a player may utilize one or more input devices and/or may utilize gestures that electronic gaming device 100, via one or more depth image sensing devices, recognizes in order to make inputs for a play of a game. A player may interact with electronic gaming device 100 via one or more depth image sensing devices for a plurality of various player inputs.

In one embodiment, one or more depth image sensing devices may include at least two similar devices. For example, each of the at least two similar devices may independently sense depth and/or image of a scene. In another example, such similar depth image sensing devices may then communicate information to one or more processors, which may utilize the information from each of the similar depth image sensing devices to determine the relative depth of an image from a captured scene.

In another embodiment, one or more depth image sensing devices may include at least two different devices. For example, and discussed in more detail below, one of the at least two different devices may be an active device and/or one of the at least two different devices may be a passive device. In one example, such an active device may generate a wave of measurable energy (e.g., light, radio, etc.). In another example, such a passive device may be able to detect reflected waves generated by such an active device. In another example, such an active device and such a passive device may each communicate data related to their respective activity to a processor, and such processor may translate such data in order to determine the depth and/or image of a scene occurring near electronic gaming device 100.

Electronic gaming device 100 may include at least one display device. Electronic gaming device 100 may include a base display and/or a second display. In one embodiment, base display may be the primary display for a first game. In another embodiment, second display may be the primary display for a second and/or bonus game. For example, base display may display: a reel-type video slot game; and upon a bonus game triggering condition; second display may display a bonus game; and upon an independent game feature triggering event; first and/or second display may display an independent game feature.

In one embodiment, base display and second display may display separate portions of a common image. For example, second display may display a top portion of a wheel spinning while base display may display the bottom portion of the same wheel spinning.

Electronic gaming device 100 may also include one or more speakers. In one embodiment, one or more speakers may work in a synchronized manner to provide a surround sound effect. For example, as an object is displayed moving across base display from left to right, one or more speakers may produce sound in such a manner as to create an audible sense of similar left to right movement. In another embodiment, one or more speakers may work asynchronously. In a further embodiment, a first speaker may produce sounds associated with a first symbol appearing in a play of a game, and a second speaker may produce sounds associated with a second symbol appearing in a play of the game.

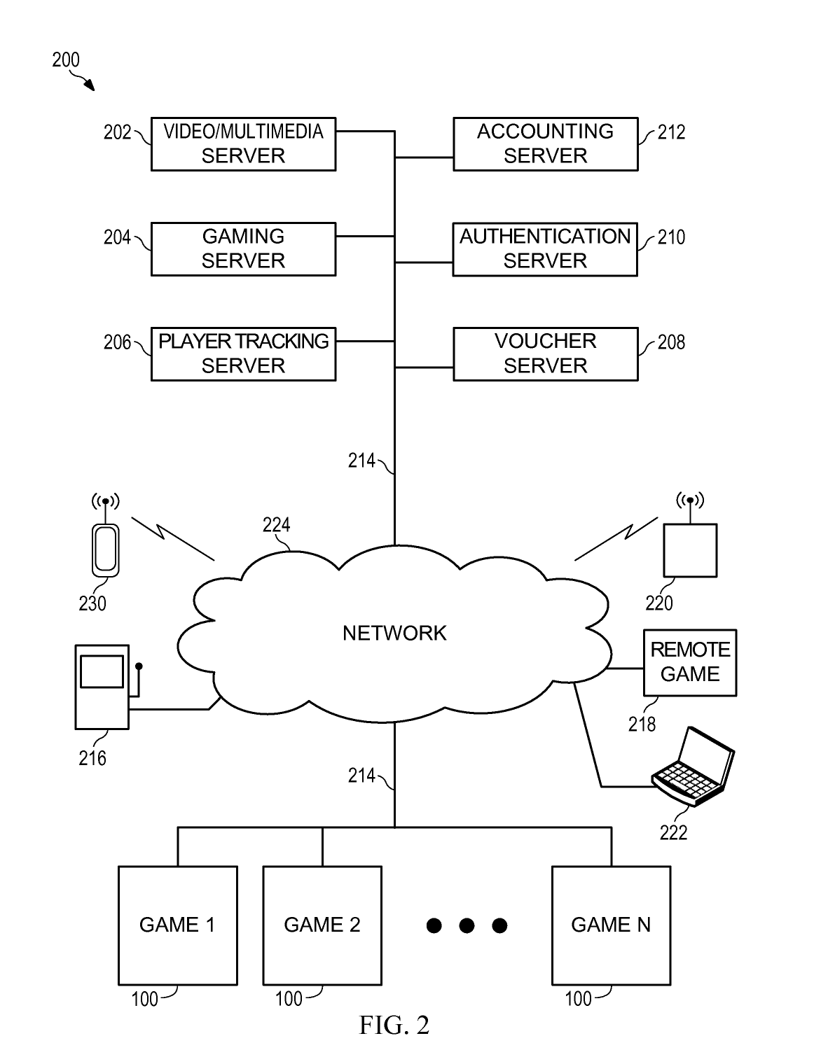

In FIG. 2, an electronic gaming system 200 is shown. Electronic gaming system 200 may include a video/multimedia server 202, a gaming server 204, a player tracking server 206, a voucher server 208, an authentication server 210, and an accounting server 212.

Electronic gaming system 200 may include video/multimedia server 202, which may be coupled to network 224 via a network link 214. Network 224 may be the Internet, a private network, and/or a network cloud. One or more video streams may be received at video/multimedia server 202 from other electronic gaming devices 100. Video/multimedia server 202 may transmit one or more of these video streams to a mobile phone 230, electronic gaming device 100, a remote electronic gaming device at a different location in the same property 216, a remote electronic gaming device at a different location 218, a laptop 222, and/or any other remote electronic device 220. Video/multimedia server 202 may transmit these video streams via network link 214 and/or network 224.

For example, a remote gaming device at the same location may be utilized at a casino with multiple casino floors, a casino that allows wagering activities to take place from the hotel room, a casino that may allow wagering activities to take place from the pool area, etc. In another example, the remote devices may be at another location via a progressive link to another casino, and/or a link within a casino corporation that owns numerous casinos (e.g., MGM, Caesars, etc.).

Gaming server 204 may generate gaming outcomes. Gaming server 204 may provide electronic gaming device 100 with game play content. Gaming server 204 may provide electronic gaming device 100 with game play math and/or outcomes. Gaming server 204 may provide one or more of: an independent game feature functionality; an independent game feature evaluation functionality; a payout functionality; a base and/or bonus game play functionality; a base and/or bonus game play evaluation functionality, other game functionality, and/or any other virtual game functionality.

Player tracking server 206 may track a player's betting activity, a player's preferences (e.g., language, font, sound level, drinks, etc.). Based on data obtained by player tracking server 206, a player may be eligible for gaming rewards (e.g., free play), promotions, and/or other awards (e.g., complimentary food, drinks, lodging, concerts, etc.).

Voucher server 208 may generate a voucher, which may include data relating to gaming. Further, the voucher may include payline structure option selections. In addition, the voucher may include game play data (or similar game play data), repeat payline data, pattern data, historical payout data, column data, row data, and/or symbols that were modified.

Authentication server 210 may determine the validity of vouchers, player's identity, and/or an outcome for a gaming event.

Accounting server 212 may compile, track, and/or monitor cash flows, voucher transactions, winning vouchers, losing vouchers, and/or other transaction data. Transaction data may include the number of wagers, the size of these wagers, the date and time for these wagers, the identity of the players making these wagers, and/or the frequency of the wagers. Accounting server 212 may generate tax information relating to these wagers. Accounting server 212 may generate profit/loss reports for players' tracked outcomes.

Network connection 214 may be used for communication between dedicated servers, thin clients, thick clients, back-office accounting systems, etc.

Laptop computer 222 and/or any other electronic devices (e.g., mobile phone 230, electronic gaming device 100, etc.) may be used for downloading new gaming device applications or gaming device related firmware through remote access.

Laptop computer 222 and/or any other electronic device (e.g., mobile phone 230, electronic gaming device 100, etc.) may be used for uploading accounting information (e.g., cashable credits, non-cashable credits, coin in, coin out, bill in, voucher in, voucher out, etc.).

Network 224 may be a local area network, a casino premises network, a wide area network, a virtual private network, an enterprise private network, the Internet, or any combination thereof. Hardware components, such as network interface cards, repeaters and hubs, bridges, switches, routers, firewalls, or any combination thereof may also be part of network 224.

A statistics server may be used to maintain data relating to historical game play for one or more electronic gaming devices 100. This historical data may include winning amounts, winning data (e.g., person, sex, age, time on machine, amount of spins before winning event occurred, etc.), fastest winning event reoccurrence, longest winning event reoccurrence, average frequencies of winning events, average winning amounts, highest winning amount, lowest winning amount, locations for winning events, winning event dates, winning machines, winning game themes, and/or any other data relating to game play.

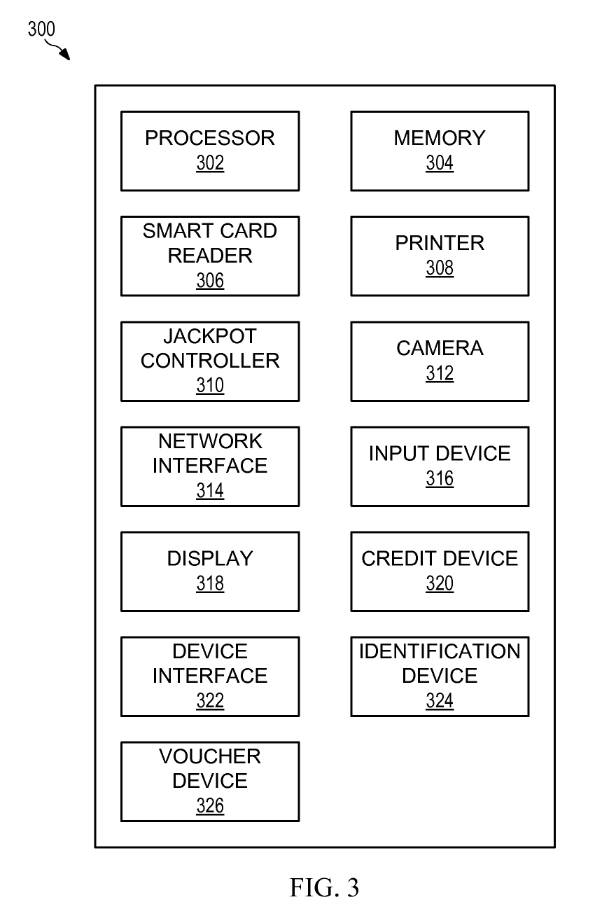

FIG. 3 shows a block diagram 300 of electronic gaming device 100. Electronic gaming device 100 may include a processor 302, a memory 304, a smart card reader 306, a printer 308, a jackpot controller 310, a camera 312, a network interface 314, an input device 316, a display 318, a credit device 320, a device interface 322, an identification device 324, and a voucher device 326.

Processor 302 may execute program instructions of memory 304 and use memory 304 for data storage. Processor 302 may also include a numeric co-processor, or a graphics processing unit (or units) for accelerated video encoding and decoding, and/or any combination thereof.

Processor 302 may include communication interfaces for communicating with electronic gaming device 100, electronic gaming system 200, and user interfaces to enable communication with all gaming elements. For example, processor 302 may interface with memory 304 to access a player's mobile device through device interface 322 to display contents onto display 318. Processor 302 may generate a voucher based on a wager confirmation, which may be received by an input device, a server, a mobile device, and/or any combination thereof. A voucher device may generate, print, transmit, or receive a voucher. Memory 304 may include communication interfaces for communicating with electronic gaming device 100, electronic gaming system 200, and user interfaces to enable communication with all gaming elements. For example, the information stored on memory 304 may be printed out onto a voucher by printer 308. Videos or pictures captured by camera 312 may be saved and stored on memory 304. Memory 304 may include a confirmation module, which may authenticate a value of a voucher and/or the validity of the voucher. Processor 302 may determine the value of the voucher based on generated voucher data and data in the confirmation module. Electronic gaming device 100 may include a player preference input device. The player preference input device may modify a game configuration. The modification may be based on data from the identification device.

Memory 304 may be non-volatile semiconductor memory, such as read-only memory (“ROM”), erasable programmable read-only memory (“EPROM”), electrically erasable programmable read-only memory (“EEPROM”), flash memory (“NVRAM”), Nano-RAM (e.g., carbon nanotube random access memory), and/or any combination thereof.

Memory 304 may also be volatile semiconductor memory such as, dynamic random access memory (“DRAM”), static random access memory (“SRAM”), and/or any combination thereof.

Memory 304 may also be a data storage device, such as a hard disk drive, an optical disk drive such as, CD, DVD, Blu-ray, a solid state drive, a memory stick, a CompactFlash card, a USB flash drive, a Multi-media Card, an xD-Picture Card, and/or any combination thereof.

Memory 304 may be used to store read-only program instructions for execution by processor 302, for the read-write storage for global variables and static variables, read-write storage for uninitialized data, read-write storage for dynamically allocated memory, for the read-write storage of the data structure known as “the stack,” and/or any combination thereof.

Memory 304 may be used to store the read-only paytable information for which symbol combinations on a given payline that result in a win (e.g., payout) which are established for games of chance, such as slot games and video poker.

Memory 304 may be used to store accounting information (e.g., cashable electronic promotion in, non-cashable electronic promotion out, coin in, coin out, bill in, voucher in, voucher out, electronic funds transfer in, etc.).

Memory 304 may be used to record error conditions on an electronic gaming device 100, such as door open, coin jam, ticket print failure, ticket (e.g., paper) jam, program error, reel tilt, etc., and/or any combination thereof.

Memory 304 may also be used to record the complete history for the most recent game played, plus some number of prior games as may be determined by the regulating authority.

Smart card reader 306 may allow electronic gaming device 100 to access and read information provided by the player or technician, which may be used for setting the player preferences and/or providing maintenance information. For example, smart card reader 306 may provide an interface between a smart card (inserted by the player) and identification device 324 to verify the identity of a player.

Printer 308 may be used for printing slot machine payout receipts, slot machine wagering vouchers, non-gaming coupons, slot machine coupons (e.g., a wagering instrument with a fixed waging value that can only be used for non-cashable credits), drink tokens, comps, and/or any combination thereof.

Electronic gaming device 100 may include a jackpot controller 310, which may allow electronic gaming device 100 to interface with other electronic gaming devices either directly or through electronic gaming system 200 to accumulate a shared jackpot.

Camera 312 may allow electronic gaming device 100 to take images of a player or a player's surroundings. For example, when a player sits down at the machine his or her picture may be taken to include his or her image into the game play. A picture of a player may be an actual image as taken by camera 312. A picture of a player may be a computerized caricature of the image taken by camera 312. The image obtained by camera 312 may be used in connection with identification device 324 using facial recognition. Camera 312 may allow electronic gaming device 100 to record video. The video may be stored on memory 304 or stored remotely via electronic gaming system 200. Videos obtained by camera 312 may then be used as part of game play, or may be used for security purposes. For example, a camera located on electronic gaming device 100 may capture videos of a potential illegal activity (e.g., tampering with the machine, crime in the vicinity, underage players, etc.).

Network interface 314 may allow electronic gaming device 100 to communicate with video/multimedia server 202, gaming server 204, player tracking server 206, voucher server 208, authentication server 210, and/or accounting server 212.

Input device 316 may be mechanical buttons, electronic buttons, a touch screen, and/or any combination thereof. Input device 316 may be utilized to make a wager, to select one or more game elements, to select one or more gaming options, to make an offer to buy or sell a voucher, to determine a voucher's worth, to cash in a voucher, to modify electronic gaming device 100 (e.g., change sound level, configuration, font, language, etc.), to modify one of one or more audio devices, one or more display devices, one or more electrical wires, one or more springs, one or more motors, one or more adjustable devices, and/or one or more sensors, to select a movie or music, to select live video streams (e.g., sporting event 1, sporting event 2, sporting event 3), to request services (e.g., drinks, manager, etc.), and/or any combination thereof.

Display 318 may show video streams from one or more content sources. Display 318 may encompass first display screen 102, second display screen 104, third display screen 106, side display screen 108, and/or another screen used for displaying video content.

Credit device 320 may be utilized to collect monies and distribute monies (e.g., cash, vouchers, etc.). Credit device 320 may interface with processor 302 to allow game play to take place. Processor 302 may determine any payouts, display configurations, animation, and/or any other functions associated with game play. Credit device 320 may interface with display 318 to display the amount of available credits for the player to use for wagering purposes. Credit device 320 may interface via device interface 322 with a mobile device to electronically transmit money and/or credits. Credit device 320 may interface with a player's pre-established account, which may be stored on electronic gaming system 200, to electronically transmit money and/or credit. For example, a player may have a credit card or other mag-stripe card on file with the location for which money and/or credits can be directly applied when the player is done. Credit device 320 may interface with a player's card to exchange player points.

Electronic gaming device 100 may include a device interface 322 that a user may employ with his or her mobile device (e.g., smart phone) to receive information from and/or transmit information to electronic gaming device 100 (e.g., watch a movie, listen to music, obtain verbal betting options, verify identification, transmit credits, etc.).

Identification device 324 may be utilized to allow electronic gaming device 100 to determine an identity of a player. Based on information obtained by identification device 324, electronic gaming device 100 may be reconfigured. For example, the language, sound level, music, placement of video streams, placement of images, placement of gaming options, and/or the tables utilized may be modified based on player preference data.

For example, a player may have selected a specific baseball team (e.g., Atlanta Braves) under the sporting event preferences, the electronic gaming device 100 will then automatically (or via player input) display the current baseball game (e.g., Atlanta Braves vs. Philadelphia Phillies) onto side display screen 108 and/or an alternate display screen as set in the player's options.

A voucher device 326 may generate, print, transmit, or receive a voucher. The voucher may represent a wagering option, a wagering structure, a wagering timeline, a value of wager, a payout potential, a payout, and/or any other wagering data. A voucher may represent an award, which may be used at other locations inside of the gaming establishment. For example, the voucher may be a coupon for the local buffet or a concert ticket.

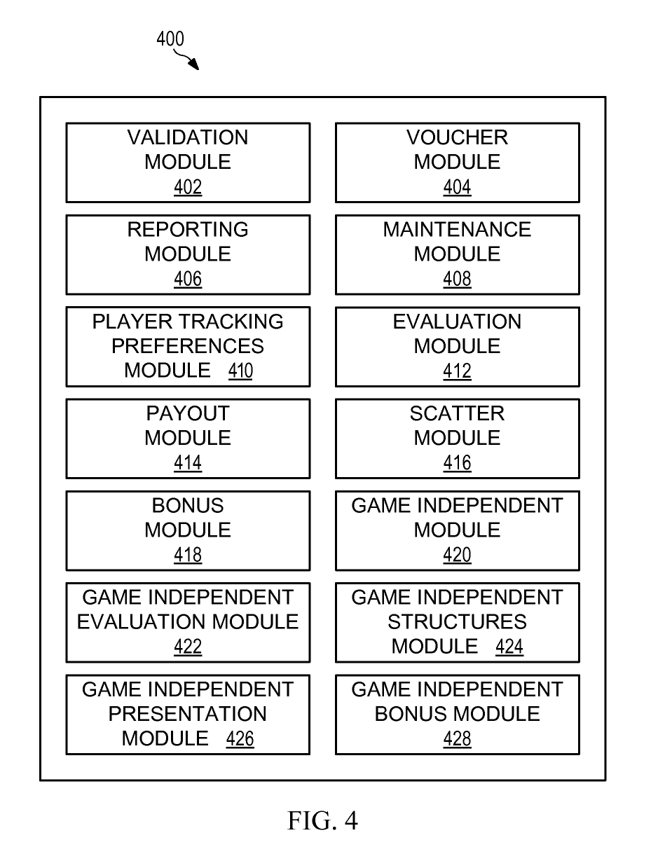

FIG. 4 shows a block diagram of memory 304, which includes various modules. Memory 304 may include a validation module 402, a voucher module 404, a reporting module 406, a maintenance module 408, a player tracking preferences module 410, an animation module, a game evaluation module 412, a payout module 414, a sensor module, a scene module, a sensor and scene evaluation module, a sensor and scene output module, a reference models module, an audio module, an audio device adjustment module, a display device adjustment module, a scatter module 416, a bonus module 418, a game independent module 420, a game independent evaluation module 422, a game independent structures module 424, a game independent presentation module 426, and a game independent bonus module 428.

Validation module 402 may utilize data received from voucher device 326 to confirm the validity of the voucher.

Voucher module 404 may store data relating to generated vouchers, redeemed vouchers, bought vouchers, and/or sold vouchers.

Reporting module 406 may generate reports related to a performance of electronic gaming device 100, electronic gaming system 200, video streams, gaming objects, credit device 114, and/or identification device 118.

Maintenance module 408 may track any maintenance that is implemented on electronic gaming device 100 and/or electronic gaming system 200. Maintenance module 408 may schedule preventative maintenance and/or request a service call based on a device error.

Player tracking preferences module 410 may compile and track data associated with a player's preferences.

Animation module may generate, compile, transmit, and/or store one or more animations and/or presentations based on one or more scene data, one or more scenes, one or more reference models, one or more game play data, one or more player profiles, and/or any combination thereof.

Game evaluation module 412 may evaluate one or more outcomes for one or more events relating to game play.

Payout module 414 may determine one or more payouts which may relate to one or more inputs received from the player, electronic gaming device 100, and/or electronic gaming system 200.

Sensor module may generate, compile, transmit, and/or store any data relating to one or more scene data, one or more scene, and/or any other sensor data. This data may include one or more gestures (e.g., body movement made by one or more players).

Scene module may generate, compile, transmit, and/or store on one or more scene data, one or more scenes, one or more reference models, one or more game play data, one or more player profiles, and/or any combination thereof.

Sensor and scene evaluation module may evaluate any data stored on, transmitted to, and/or transmitted from sensor module and scene module. Sensor and scene evaluation module may obtain data including one or more gestures (e.g., body movement made by one or more players) from sensor module and compare this data to one or more body reference models, body part reference models, device reference models, gaming device reference models, floor plan reference models, and/or any other reference models from reference models module to determine one or more actions.

Sensor and scene output module may evaluate the combined output of sensor module and scene module.

Reference models module may generate, compile, transmit, and/or store one or more body reference models, body part reference models, device reference models, gaming device reference models, floor plan reference models, and/or any other reference models which can be utilized by any of the other modules.

Audio module may generate, compile, transmit, and/or store one or more audio structures, sound wave configurations, and/or any other audio data.

Audio device adjustment module may adjust one or more audio devices. These devices may be adjusted physically (e.g., moved) and/or by changing one or more device characteristics.

Display device adjustment module may adjust one or more display devices. These devices may be adjusted physically (e.g., moved) and/or by changing one or more device characteristics.

Scatter module 416 may generate a scatter game, evaluate the results of the scatter game, trigger scatter game presentations, generate scatter game payouts, and/or display any data relating to the scatter game.

Bonus module 418 may generate a bonus game, evaluate the results of the bonus game, trigger bonus game presentations, generate bonus game payouts, and/or display any data relating to the bonus game.

Game independent module 420 may generate, compile, transmit, and/or store on one or more independent feature data, one or more independent feature structures, one or more independent feature models, one or more independent feature game play data, one or more player profiles, and/or any combination thereof.

Game independent evaluation module 422 may generate an independent feature game, evaluate the results of the independent feature game, trigger independent feature game presentations, generate independent feature game payouts, and/or display any data relating to the independent feature game.

Game independent structures module 424 may generate, compile, transmit, and/or store on one or more independent feature data, one or more independent feature structures, and/or one or more independent feature models.

Game independent presentation module 426 may generate, compile, transmit, and/or store one or more independent feature game presentations.

Game independent bonus module 428 may generate, compile, transmit, and/or store on one or more independent feature bonus game data, one or more independent feature bonus game structures, one or more independent feature bonus game models, one or more independent feature bonus game play data, one or more player profiles, and/or any combination thereof.

Installation verification module may verify the installation parameters on one or more of audio devices, one or more display devices, one or more electrical wires, one or more springs, one or more motors, one or more adjustable devices, and/or one or more sensors to one or more reference data points. Installation verification module may generate a warning when the data points are outside of a specific parameter range. One or more warnings may be transmitted to an external device, a server, a mobile device, and/or a warning display on electronic gaming device 100 based on the verification data.

Locking module may control the locking mechanism for one or more audio devices, one or more display devices, one or more electrical wires, one or more springs, one or more motors, one or more adjustable devices, and/or one or more sensors. Locking module may control any locking mechanism for electronic gaming device 100. Locking module may generate a warning when a locking data point is outside of a specific parameter. These warnings may be transmitted to an external device, a server, a mobile device, and/or a warning display on electronic gaming device 100.

It should be noted that one or more modules may be combined into one module. Further, there may be one evaluation module where the determined payout does not depend on whether there were any wild symbols, scatter symbols, platform based game play, and/or any other specific symbols. Further, any module, device, and/or logic function in electronic gaming device 100 may be present in electronic gaming system 200. In addition, any module, device, and/or logic function in electronic gaming system 200 may be present in electronic gaming device 100.

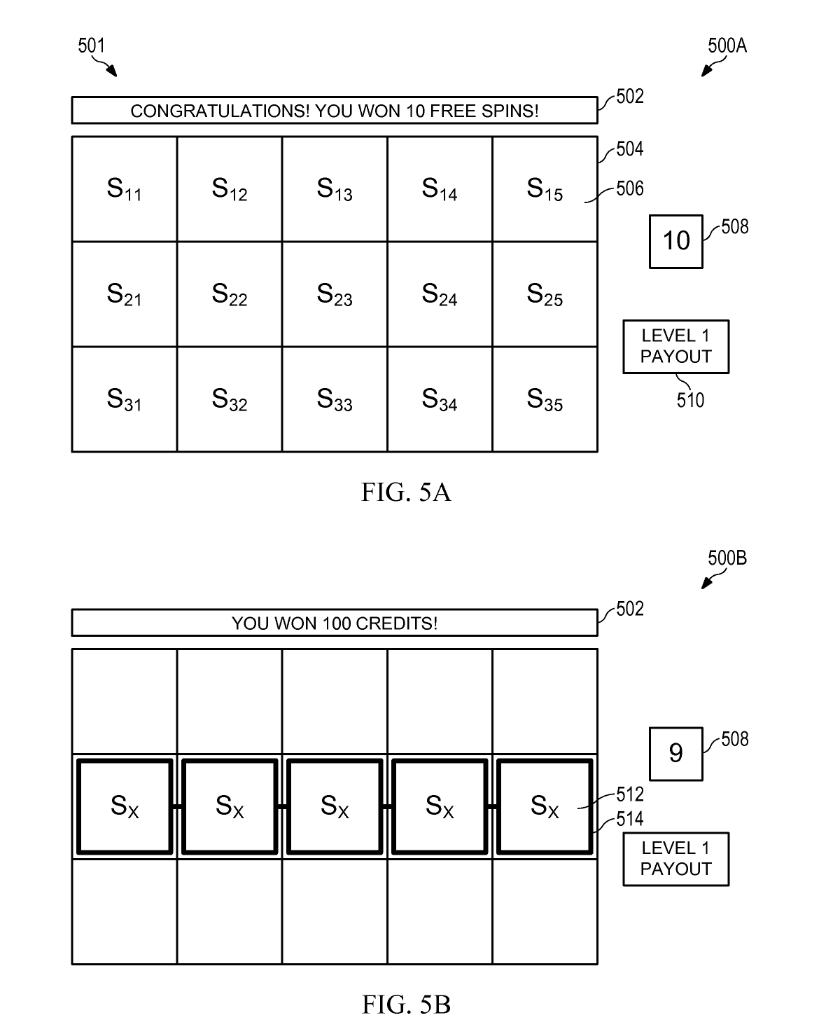

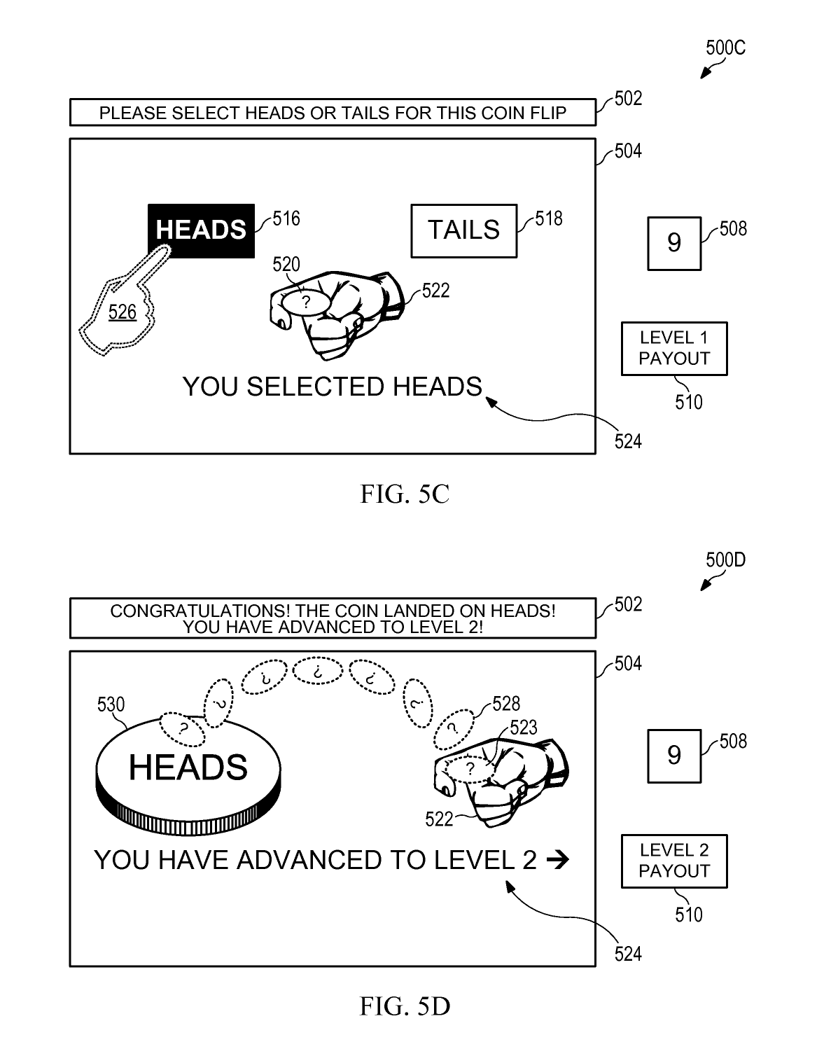

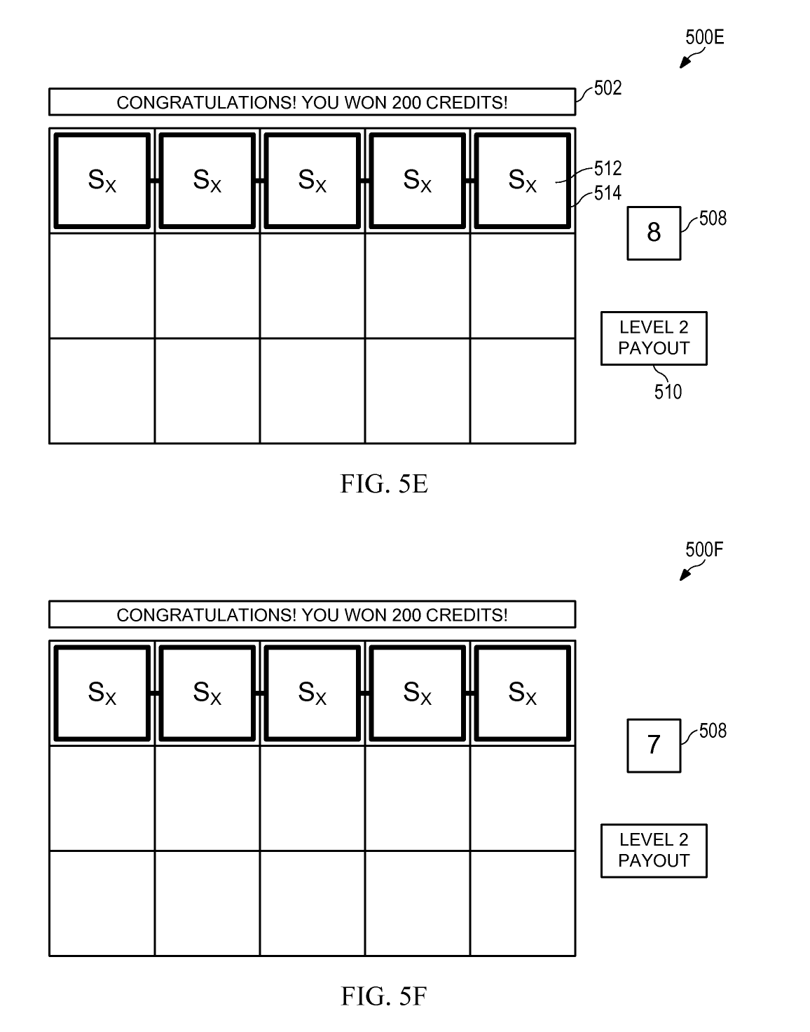

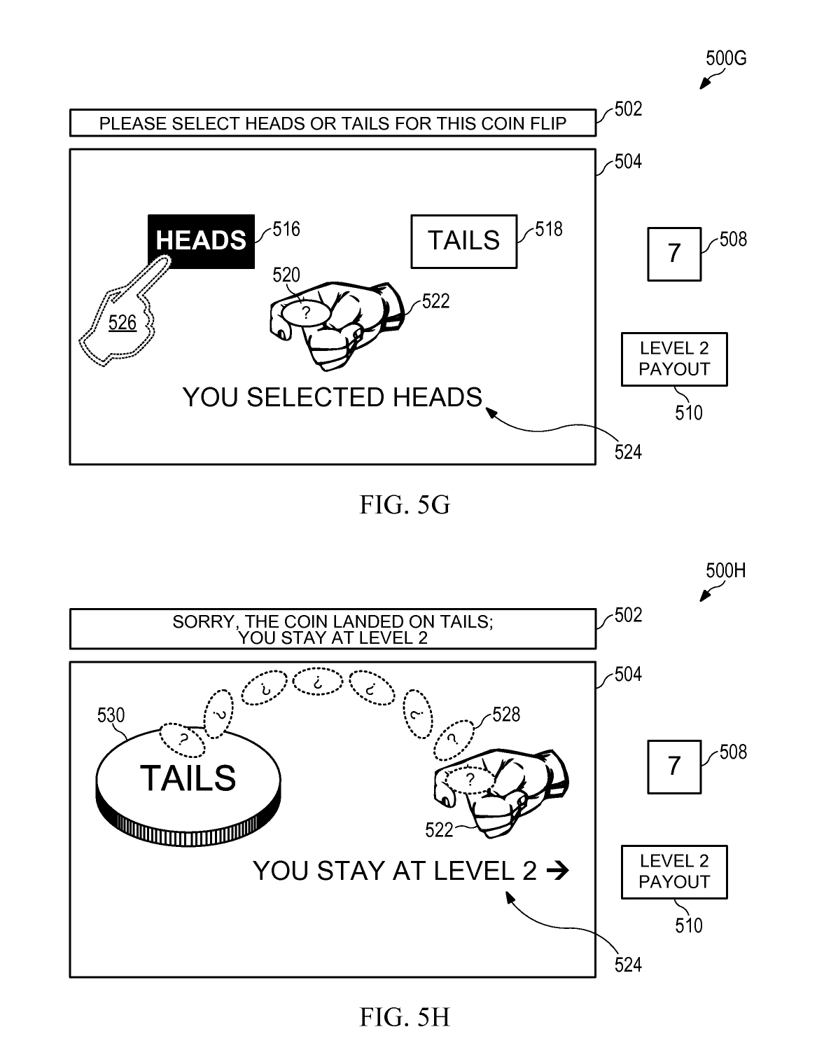

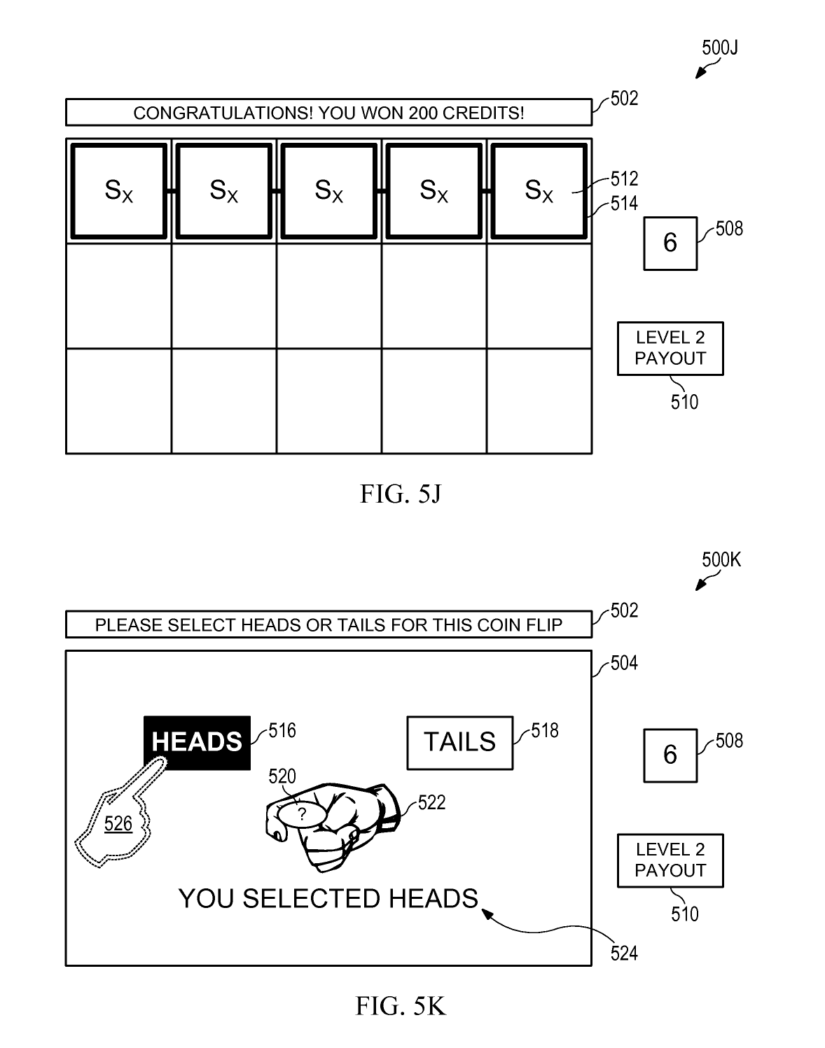

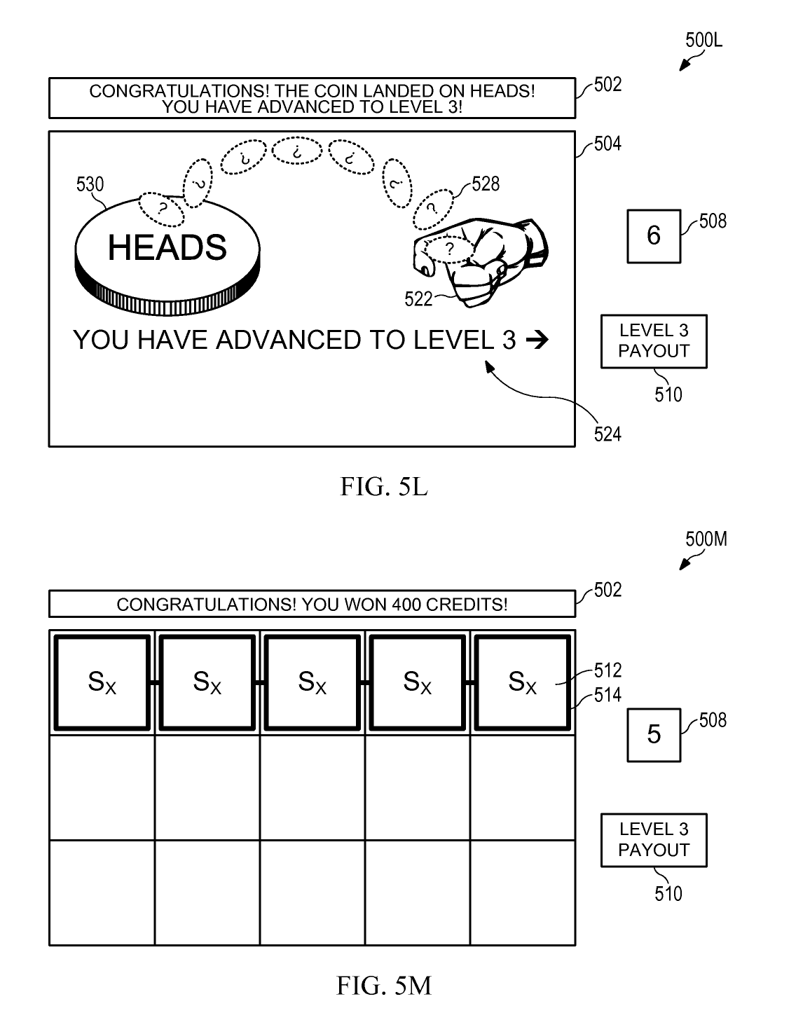

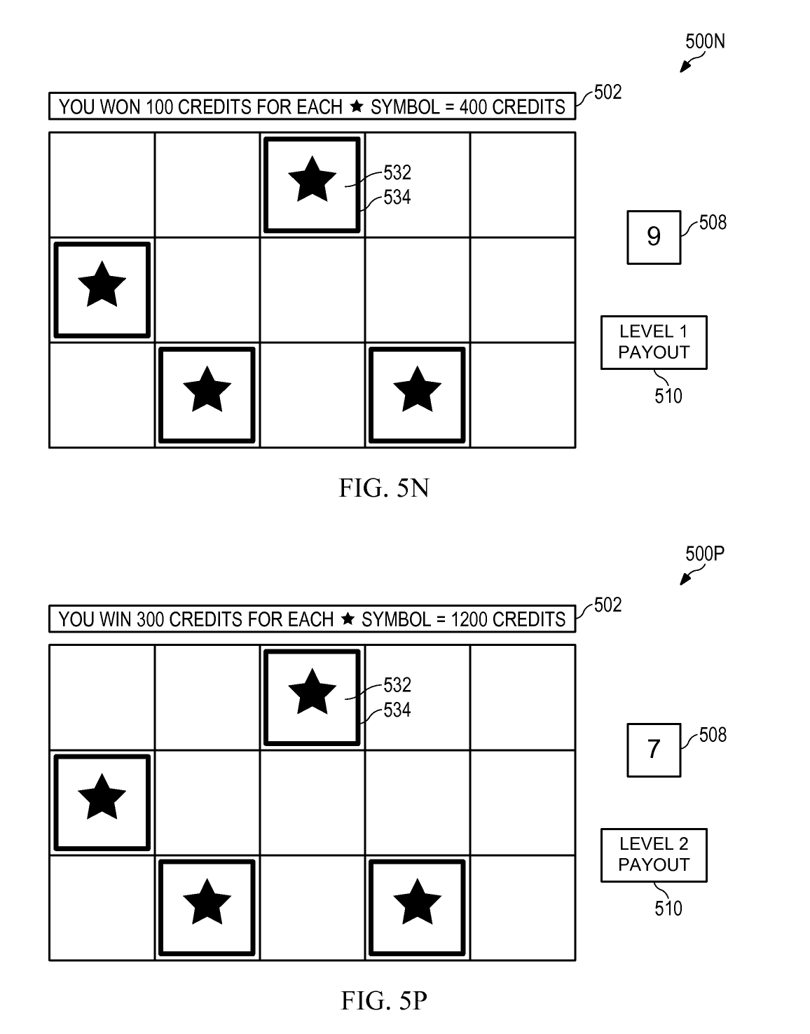

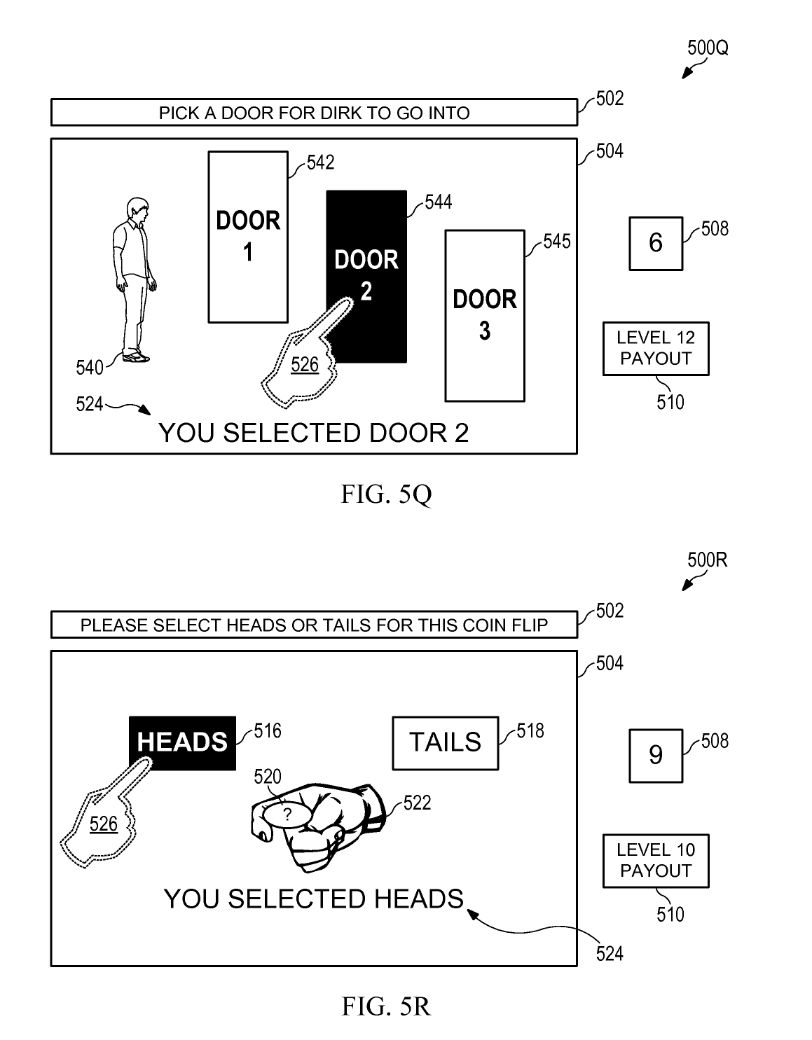

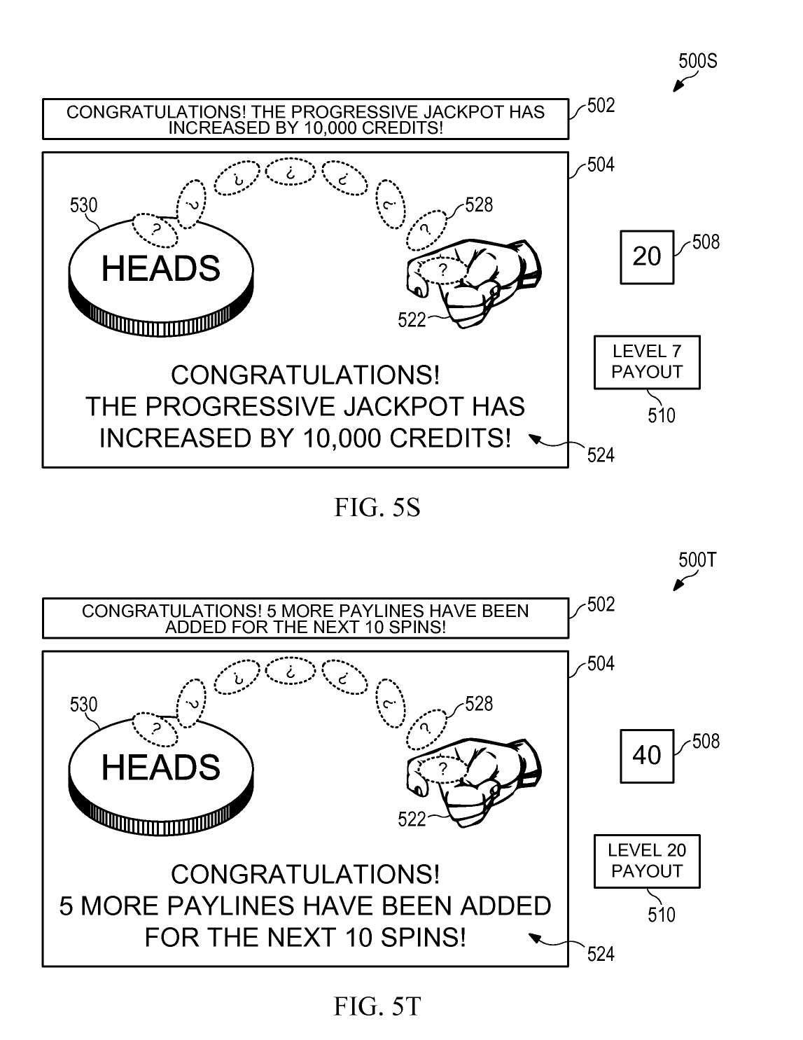

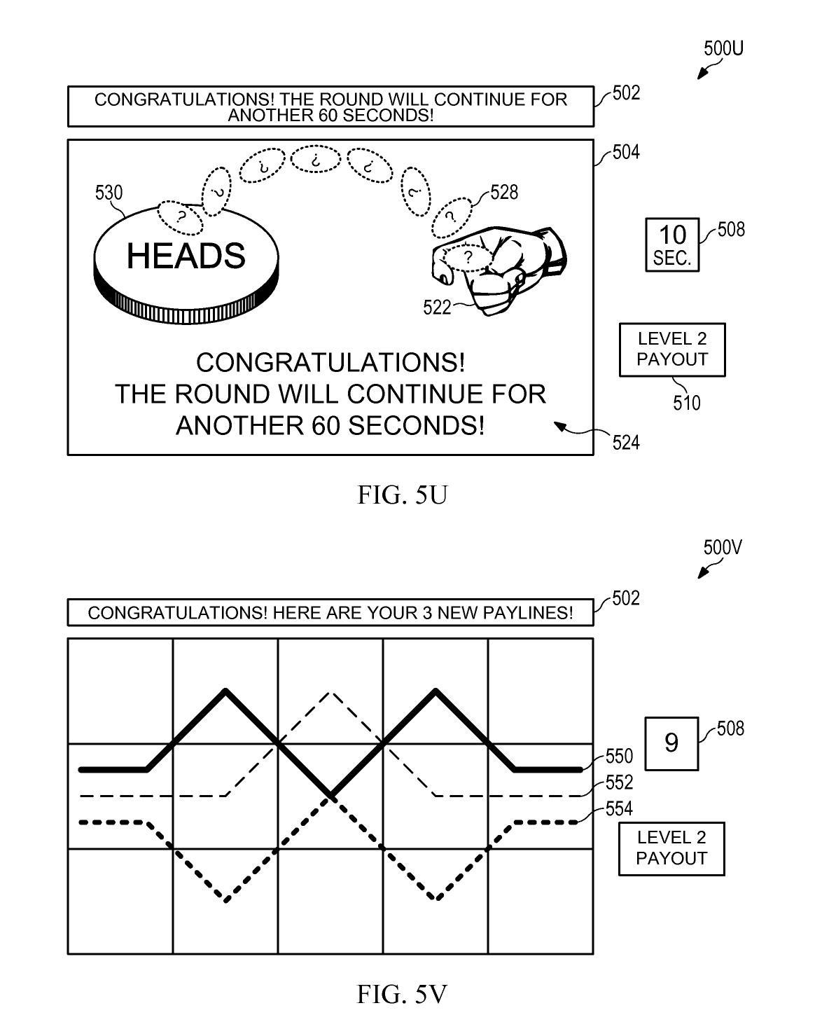

In FIG. 5A, an illustration of game play on a gaming device 500A is shown, according to one embodiment. In one example, a display screen 501 may include a message area 502, a plurality of reels 504, one or more symbols 506, a free spin counter 508, and a game level counter 510. In this example, the game play has resulted in ten free spins being awarded. In this example, message area 502 may state “CONGRATULATIONS! YOU WON 10 FREE SPINS!” Free spin counter 508 may show the ten free spins by utilizing the number 10. In this example, game level counter 510 is at level one.

In FIG. 5B, another illustration of game play on a gaming device 500B is shown, according to one embodiment. In this example, game play has resulted in a winning combination (e.g., 5 Sx symbols 512 on a payline 514). In this example, the player has won 100 credits based on game level play being at one. Further, free spin counter 508 now indicates that 9 free spins remain.

In FIG. 5C, another illustration of game play on a gaming device 500C is shown, according to one embodiment. In this example, an independent feature has been triggered. This independent feature is be totally independent from any game result. In one example, there may be a first random number generator (or similar functionality) for a base game and/or a bonus game and a second random number generator (or similar functionality) for the independent game feature. In this example, the player is requested to select either a heads option 516 or a tails option 518 via a hand 526. In this example, message area 502 may state “PLEASE SELECT HEADS OR TAILS FOR THE COIN FLIP”. Further, a virtual hand 522 may be shown with a virtual coin 520. A confirmation message 524 may state “YOU SELECTED HEADS”. Further, the game play is frozen/halted and the free spin count of 9 in free spin counter 508 remains at 9 because this event is independent of the game play. In addition, game level counter 510 remains at one because this independent feature is independent of the game play. In a further example, virtual coin 520 is flipped by virtual hand 522 as illustrated by one or more moving coin images 528 (see FIG. 5D). Referring to FIG. 5D, virtual coin 520 has landed on a heads outcome 530. Since the player selected heads and the virtual coin 520 landed on heads, the player may advance to a level 2 payout (e.g., level 2 game play). Message area 502 may state “CONGRATULATIONS! THE COIN LANDED ON HEADS! YOU ADVANCED TO LEVEL 2!”. In this example, game level counter 510 may be increased to a level 2 payout status. In one example, the first random number generator determines that the outcome of a first spin is not a winning spin. However, the independent feature is triggered, the player picks an option, a second random number is generated, the player's pick and the second random number outcome determines that a successful event has occurred, and a prize is awarded based on this successful event occurrence completely independent of the first random number generating event (e.g., base game and/or bonus game).

In FIG. 5E, another illustration of game play on a gaming device 500E is shown, according to one embodiment. In this example, game play may have resulted in a winning combination (e.g., 5 Sx symbols 512 on payline 514). In this example, the 100 credits payout (see FIG. 5B where the payout for 5 Sx symbols 512 was 100 credits) may have been increased to 200 credits because game play level is now at level 2. Since one free spin has been utilized, free spin counter 508 is now at 8. It should be noted that moving from a first game play level to a second game play level may increase a credit multiplier (e.g., 1× to 2×, 2× to 4×, etc.), increase a payout by a set amount (e.g., 100 credits, 500 credits, etc.), increase the number of wild symbols available (e.g., 1 to N, 2 to N, etc.), increase the number of scatter symbols available (e.g., 1 to N, 2 to N, 3 to N, etc.), increase the probability of rewarding free spins, increase the probability of winning a prize, increase the probability of winning anything of value (e.g., food, room, show tickets, etc.), and/or any combination thereof.

In FIG. 5F, another illustration of game play on a gaming device 500F is shown, according to one embodiment. In this example, game play may have resulted in a winning combination (e.g., 5 Sx symbols 512 on payline 514). In this example, the 100 credits payout (see FIG. 5B where the payout for 5 Sx symbols 512 was 100 credits) may have been increased to 200 credits because game play level is now at level 2. Since one free spin has been utilized, free spin counter 508 is now at 7.

In FIG. 5G, another illustration of game play on a gaming device 500G is shown, according to one embodiment. In this example, an independent feature (e.g., coin flip, door selection, etc.) has been triggered. This independent feature may be totally independent from any game result. In this example, the player is requested to select either heads option 516 or tails option 518 via hand 526. In this example, message area 502 may state “PLEASE SELECT HEADS OR TAILS FOR THE COIN FLIP”. Further, virtual hand 522 may be shown with virtual coin 520. Confirmation message 524 may state “YOU SELECTED HEADS”. Further, the game play is frozen/halted and the free spin count of 7 in free spin counter 508 remains at 7 because this event is independent of the game play. In addition, game level counter 510 remains at two because this independent feature is independent of the game play. In a further example, virtual coin 520 is flipped by virtual hand 522 as illustrated by one or more moving coin images 528 (see FIG. 5H). Referring to FIG. 5H, virtual coin 520 has landed on a tails outcome 531. Since the player selected heads and the virtual coin 520 landed on tails, the player may not advance to a level 3 payout (e.g., level 3 game play). Message area 502 may state “YOU STAY AT LEVEL 2->”. In this example, game level counter 510 may not be increased to a level 3 payout status but remains at a level 2 payout state.

In FIG. 5J, another illustration of game play on a gaming device 500J is shown, according to one embodiment. In this example, game play may have resulted in a winning combination (e.g., 5 Sx symbols 512 on payline 514). In this example, the 100 credits payout (see FIG. 5B where the payout for 5 Sx symbols 512 was 100 credits) may have been increased to 200 credits because game play level remained at level 2. Since one free spin has been utilized, free spin counter 508 is now at 6.

In FIG. 5K, another illustration of game play on a gaming device 500K is shown, according to one embodiment. In this example, an independent feature (e.g., roll dice, aim arrow, etc.) has been triggered. This independent feature may be totally independent from any game result. In this example, the player is requested to select either heads option 516 or tails option 518 via hand 526. In this example, message area 502 may state “PLEASE SELECT HEADS OR TAILS FOR THE COIN FLIP”. Further, virtual hand 522 may be shown with virtual coin 520. Confirmation message 524 may state “YOU SELECTED HEADS”. Further, the game play is frozen/halted and the free spin count of 6 in free spin counter 508 remains at 6 because this event is independent of the game play. In addition, game level counter 510 remains at two because this independent feature is independent of the game play. In a further example, virtual coin 520 is flipped by virtual hand 522 as illustrated by one or more moving coin images 528 (see FIG. 5L). Referring to FIG. 5L, virtual coin 520 has landed on heads outcome 530. Since the player selected heads and the virtual coin 520 landed on heads, the player may advance from a level 2 payout (e.g., level 2 game play) to a level 3 payout (e.g., level 3 game play). Message area 502 may state “CONGRATULATIONS! THE COIN LANDED ON HEADS! YOU ADVANCED TO LEVEL 3->”. In this example, game level counter 510 may be increased to a level 3 payout status. In various examples, any number of levels may be advanced (e.g., 1/2, 1, 3/2, 2, 4, 5, etc.).

In FIG. 5M, another illustration of game play on a gaming device 500M is shown, according to one embodiment. In this example, game play may have resulted in a winning combination (e.g., 5 Sx symbols 512 on payline 514). In this example, the 100 credits payout (see FIG. 5B where the payout for 5 Sx symbols 512 was 100 credits) may have been increased to 400 credits because game play level remained at level 3. Since one free spin has been utilized, free spin counter 508 is now at 5.

In FIG. 5N, another illustration of game play on a gaming device 500N is shown, according to one embodiment. In this example, when one or more specific symbols (e.g., stars, cherries, aces, etc.) appear on the active part of one or more reels, a prize (e.g., credits, free spins, multipliers, etc.) is awarded. In one example, there may be a threshold number of symbols before an award is generated (e.g., 2, 3, 4, 5, etc.). In this example, when a star symbol 532 appears in one or more symbol areas 534, 100 credits is awarded based on game play being at a level one game play, which is indicated in game level counter 510. Message area 502 may state “YOU WON 100 CREDITS FOR EACH STAR SYMBOL=400 CREDITS” (4 Star Symbols times 100 credits per Star symbol=400 Credits). In this example, free spin counter 508 is at 9. In another example illustrated by FIG. 5P, when the game play is at a level 2 game play, which is indicated by game level counter 510 (e.g., Level 2 payout, Level 2 game play, etc.), then the 4 Star symbols may be worth 300 credits each. Therefore, message area 502 may state “YOU WON 300 CREDITS FOR EACH STAR SYMBOL=1200 CREDITS” (4 Star Symbols times 300 credits per Star symbol=1200 Credits). In this example, free spin counter 508 is at 7.

In FIG. 5Q, another illustration of game play on a gaming device 500Q is shown, according to one embodiment. In this example, instead of selecting a head options or a tail options, the player selects one or more selection objects (e.g., a door, a lane, a horse, a car, a character, etc.) to determine the independent outcome. In this example, an independent feature has been triggered. This independent feature may be totally independent from any game result. In this example, the player may select a first door 542, a second door 544, and/or a third door 545. The player selected second door 544 for Dirk (e.g., a person's image 540) to go into. Message area 502 may state “PICK A DOOR FOR DIRK TO GO INTO”. Confirmation message 524 may state “YOU SELECTED DOOR 2”. In various examples, there may be positive outcomes behind one or more objects (e.g., the doors, etc.). For example, a pot of gold (e.g., credits), an upgraded game play level (e.g., going from a first game level to a second game level—Dirk lives), etc. In various examples, there may be negative outcomes behind one or more objects (e.g., the doors, etc.). For example, no upgraded game play level (e.g., stays at the current game level—Kirk dies). In this example, game level counter 510 is at 12.

In FIG. 5R, another illustration of game play on a gaming device 500R is shown, according to one embodiment. In this example, an independent feature has been triggered. This independent feature may be totally independent from any game result and/or game activity. In this example, the player is requested to select either heads option 516 or tails option 518 via hand 526. In this example, message area 502 may state “PLEASE SELECT HEADS OR TAILS FOR THE COIN FLIP”. Further, virtual hand 522 may be shown with virtual coin 520. Confirmation message 524 may state “YOU SELECTED HEADS”. Further, the game play is frozen/halted and the free spin count of 9 in free spin counter 508 remains at 9 because this event is independent of the game play. In addition, game level counter 510 remains at ten because this independent feature is independent of the game play. In a further example, virtual coin 520 is flipped by virtual hand 522.

In FIG. 5S, another illustration of game play on a gaming device 500S is shown, according to one embodiment. In a further example, virtual coin 520 is flipped by virtual hand 522 as illustrated by one or more moving coin images 528. Virtual coin 520 has landed on head outcome 530. Since the player selected heads and the virtual coin 520 landed on heads, game play may increase one or more progressive jackpot by a specific amount (e.g., 10,000 Credits). Message area 502 may state “CONGRATULATIONS! THE PROGRESSIVE JACKPOT HAS INCREASED BY 10,000 CREDITS!”. In this example, game level counter 510 may stay at a game level 7 and free spin counter 508 remains at 20 because this event is independent of the game play.

In FIG. 5T, another illustration of game play on a gaming device 500T is shown, according to one embodiment. In a further example, virtual coin 520 is flipped by virtual hand 522 as illustrated by one or more moving coin images 528. Virtual coin 520 has landed on head outcome 530. Since the player selected heads and the virtual coin 520 landed on heads, game play may increase the number of paylines for a number of spins (e.g., 5 more paylines have been added for the next 10 spins). Message area 502 may state “CONGRATULATIONS! 5 MORE PAYLINES HAVE BEEN ADDED FOR THE NEXT 10 SPINS!”. In this example, game level counter 510 may stay at a game level 20 and free spin counter 508 remains at 40 because this event is independent of the game play. In one example, the five paylines are paylines that are not part of base game and/or bonus game play. In one example, the five paylines are paylines that are part of base game and/or bonus game play.

In FIG. 5U, another illustration of game play on a gaming device 500U is shown, according to one embodiment. In a further example, virtual coin 520 is flipped by virtual hand 522 as illustrated by one or more moving coin images 528. Virtual coin 520 has landed on head outcome 530. Since the player selected heads and the virtual coin 520 landed on heads, game play may increase a time period for free game play. In this example, game play was only going to be in free play mode for another 10 seconds. However, based on having a successful selection (e.g., choosing wisely) on the heads/tails flip, free play mode may be increased by 60 seconds. Message area 502 may state “CONGRATULATIONS! THE ROUND WILL CONTINUE FOR ANOTHER 60 SECONDS!”. In this example, game level counter 510 may stay at a game level 2 and free spin counter 508 increases from 10 seconds to 70 seconds.

In FIG. 5V, another illustration of game play on a gaming device 500V is shown, according to one embodiment. In a further example, virtual coin 520 is flipped by virtual hand 522 as illustrated by one or more moving coin images 528 (see FIG. 5T). Virtual coin 520 has landed on head outcome 530. Since the player selected heads and the virtual coin 520 landed on heads, game play may increase the number of paylines for a number of spins (e.g., 3 more paylines have been added). Message area 502 may state “CONGRATULATIONS! HERE ARE YOUR 3 NEW PAYLINES!”. In this example, game level counter 510 may stay at a game level 2 and free spin counter 508 remains at 9 because this event is independent of the game play. In this example, a first new payline 550, a second new payline 552, and a third new payline 554 were added to game play. In one example, first new payline 550, second new payline 552, and third new payline 554 are paylines that are not part of base game and/or bonus game play. In one example, first new payline 550, second new payline 552, and third new payline 554 are paylines that are part of base game and/or bonus game play.

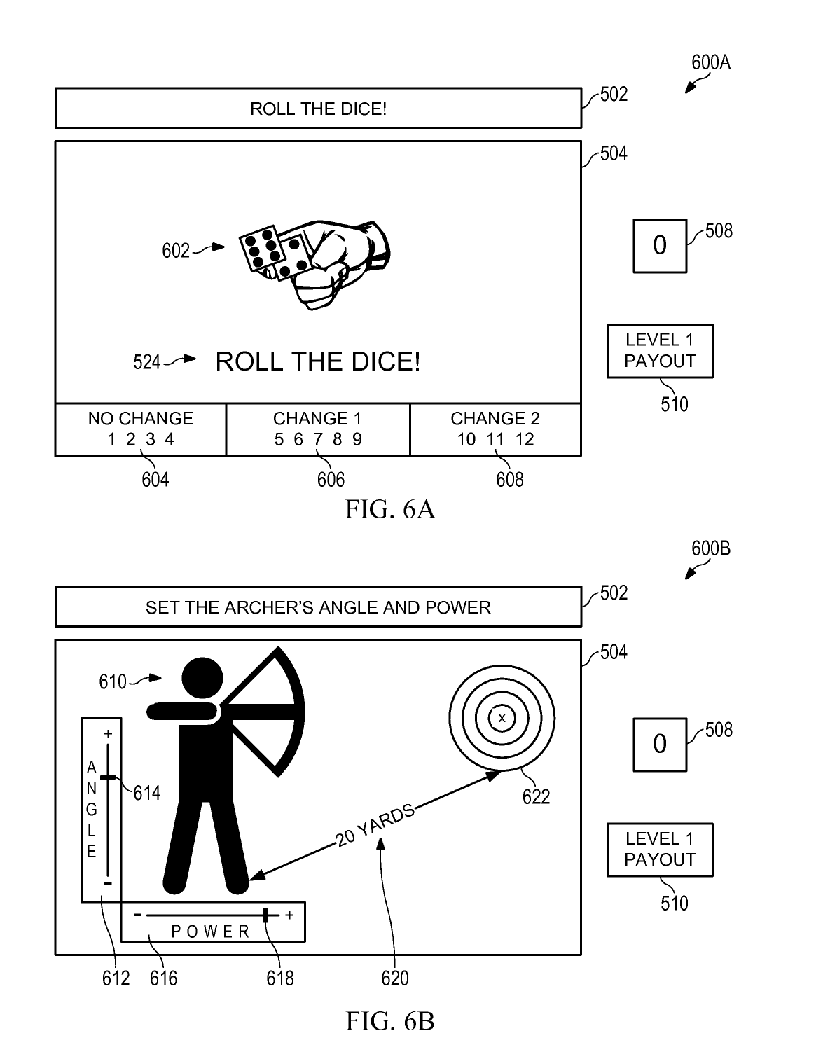

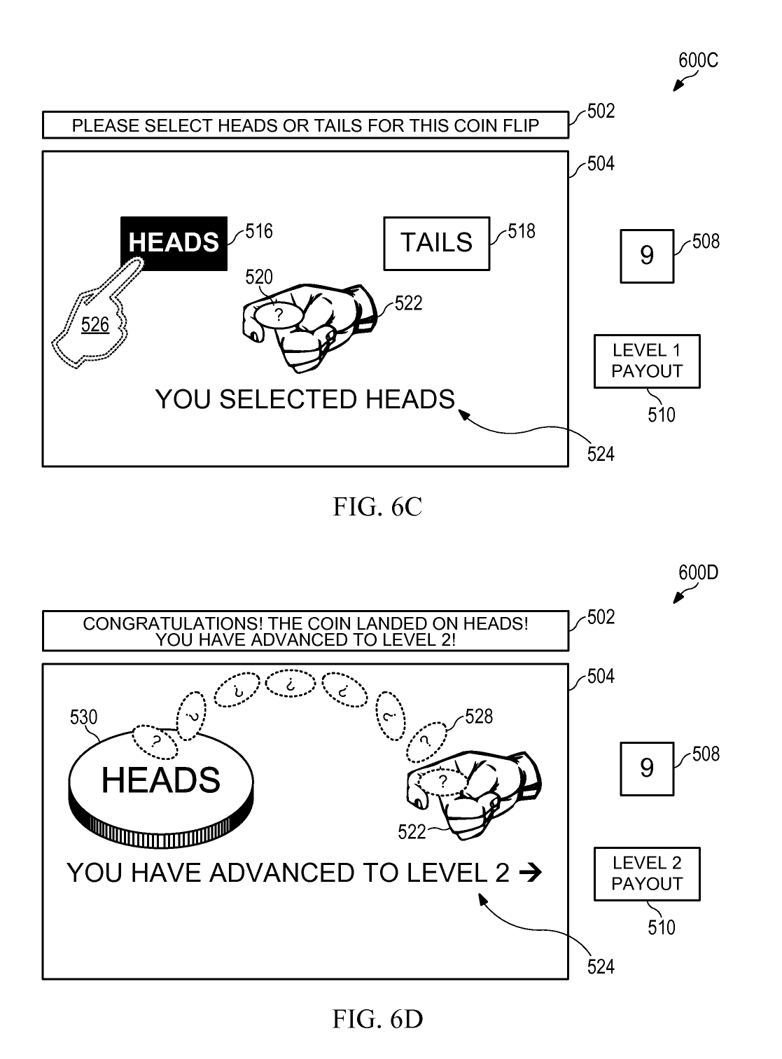

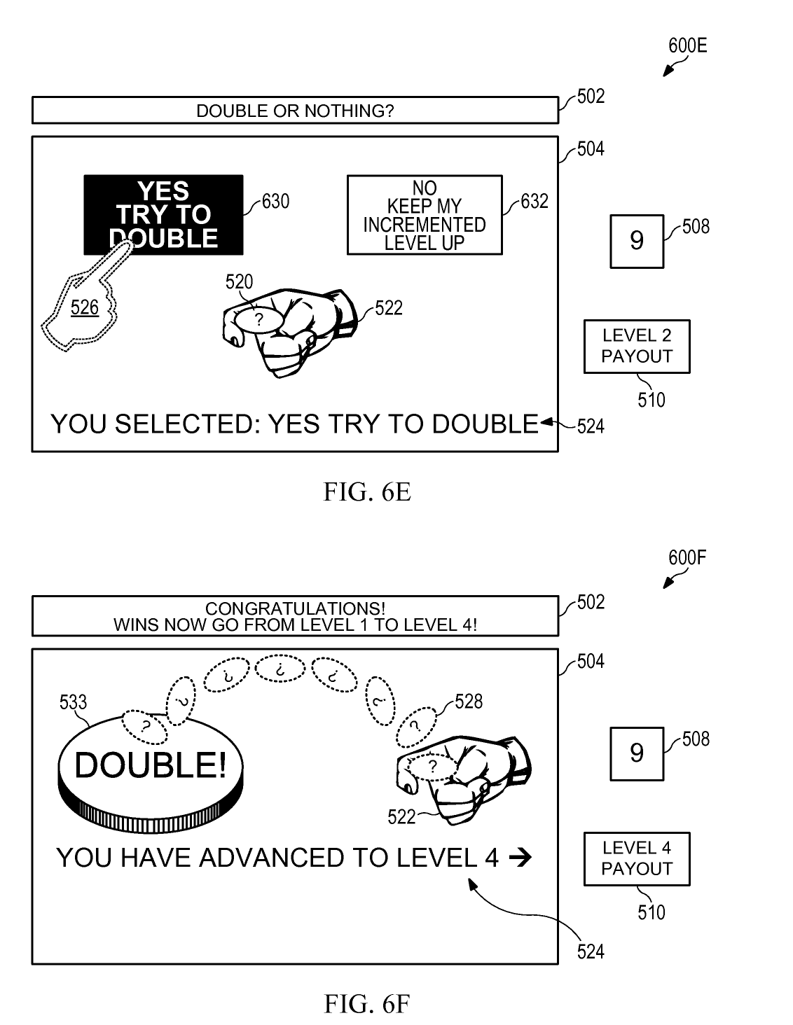

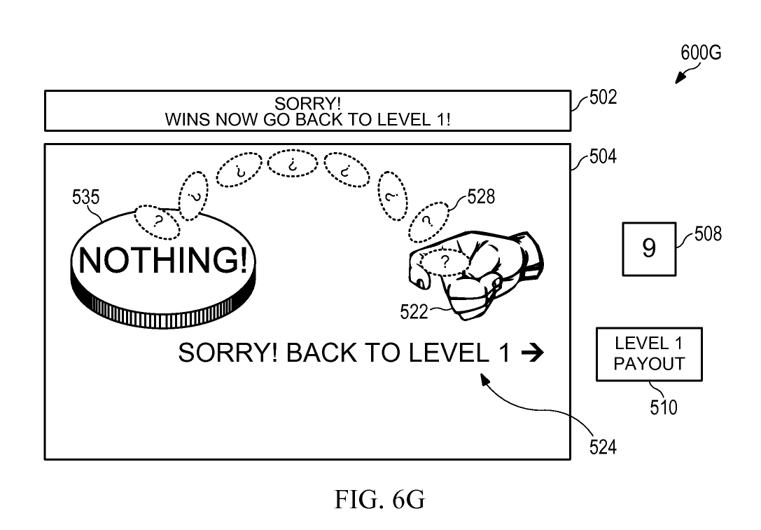

In FIG. 6A, another illustration of game play on a gaming device 600A is shown, according to one embodiment. In this example, the independent game feature may be based on rolling of dice. In this example, a player (or the gaming device) may roll the dice to determine an outcome (e.g., a number from 1 to 12). In this example, if the number is within a first number range 604 (e.g., 1 to 4), then the game level may not change. If the number is within a second range 606 (e.g., 5 to 9), then the game level may be increased by a first delta (e.g., change from a first level to a second level, etc.). If the number is within a third range 608 (e.g., 10 to 12), then the game level may be increased by a second delta (e.g., change from a first level to a third level, etc.).

In FIG. 6B, another illustration of game play on a gaming device 600B is shown, according to one embodiment. In this example, the independent game feature may be a skill-based option, a semi-skill-based option, and/or a perceived skill-based option. In this example, a character image 610 may aim a tool (e.g., bow and arrow, gun, etc.) at a first target 622 at a first distance away 620 via an angle input area 612 and a power input area 616. The player and/or the gaming device may provide input via an input angle pointer 614 and/or an input power pointer 618. In one example, the outcome is dependent (e.g., skill-based game play) on the inputs provided via input angle pointer 614 and/or input power pointer 618. In another example, the outcome is semi-dependent (e.g., semi-skill-based game play) on the inputs provided via input angle pointer 614 and/or input power pointer 618. In another example, the outcome is independent (e.g., perceived skill-based game play) on the inputs provided via input angle pointer 614 and/or input power pointer 618.

In FIG. 6C, another illustration of game play on a gaming device 600C is shown, according to one embodiment. In this example, an independent feature has been triggered. This independent feature may be totally independent from any game result and/or game activity. In this example, the player is requested to select either heads option 516 or tails option 518 via hand 526. In this example, message area 502 may state “PLEASE SELECT HEADS OR TAILS FOR THE COIN FLIP”. Further, virtual hand 522 may be shown with virtual coin 520. Confirmation message 524 may state “YOU SELECTED HEADS”. Further, the game play is frozen/halted and the free spin count of 9 in free spin counter 508 remains at 9 because this event is independent of the game play. In addition, game level counter 510 remains at one because this independent feature is independent of the game play. In a further example, virtual coin 520 is flipped by virtual hand 522 as illustrated by one or more moving coin images 528 (see FIG. 6D). Referring to FIG. 6D, virtual coin 520 has landed on a heads outcome 530. Since the player selected heads and the virtual coin 520 landed on heads, the player may advance to a level 2 payout (e.g., level 2 game play). Message area 502 may state “CONGRATULATIONS! THE COIN LANDED ON HEADS! YOU ADVANCED TO LEVEL 2!”. In this example, game level counter 510 may be increased to a level 2 payout status.

Referring to FIG. 6E, another illustration of game play on a gaming device 600E is shown, according to one embodiment. In this example, game play may include allowing the player to either try to go for doubling (e.g., a doubling option 630) the increased game play level (or obtain nothing if you loss the next round) or to keep their current game play level increase (e.g., a keep my current level option 632). In this example, the player selected doubling option 630. Confirmation message may state “YOU SELECTED YES (DOUBLE) OPTION”. Therefore, the player gave up increasing their power level from a power level of 1 to a power level of 2. In this example, virtual coin 520 has landed on a double image 533, which means the player level has been increased from a power level of 1 to a power level of 4 (see FIG. 6F). In another example, virtual coin 520 has landed on a nothing image 535, which means the player level remains at a power level of 1 (see FIG. 6G). In various examples, the amount may be doubled, tripled, any other multiplier, credits, chances at a progressive, anything of value, and/or any combination thereof.

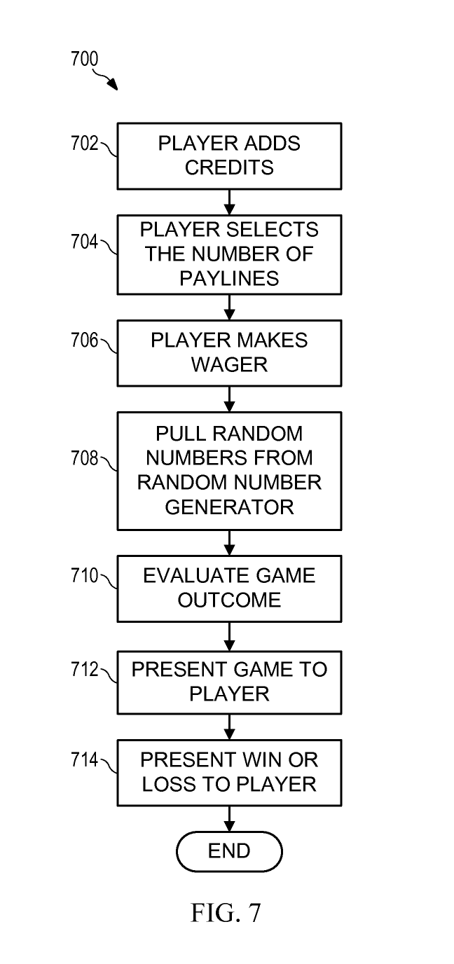

FIG. 7 is a process flowchart of one example of a primary game play 700 on an electronic gaming system, according to one embodiment. The method may include the step of a player adding credit to the electronic gaming system (step 702). It is contemplated that a player can do this by inserting cash, coins, a ticket representative of a cash value, a credit card, a player card, requesting an electronic funds transfer (“EFT”), otherwise requesting access to an account having monetary funds, and/or any combination thereof.

At step 704, the player selects the number of paylines to play. In one embodiment, the player can select from a plurality of different paylines to play. In a further embodiment, the player can only play a predetermined number of paylines. An example of this embodiment may be the instance where the gaming system only allows a player to play forty paylines, and cannot select to play more or less paylines. In another embodiment, the gaming system does not offer paylines, but rather offers a different way to evaluate the game play. One example of a different way may be sometime referred to as a 243-ways evaluation, where symbols may be evaluated based on the existence of like-symbol clusters on adjacent reels, starting with the left-most reel and continuing right, instead of how many paylines run through the like-symbol clusters.

At step 706, the player makes a wager on the game. In one embodiment, the wager may be a multiple of the number of paylines selected at step 704. In another embodiment, the wager may not be a multiple of the number of paylines selected at step 704. In a further embodiment, the wager may include a side-wager (e.g., ante bet), which may, in one example of such an embodiment, be used to make the player eligible to be awarded the extra functionality discussed above. It should be appreciated that in some embodiments, the order of steps 704 and 706 may be not critical, and so for example, a player can select the wager they wish to place, and then select the number of paylines they want it applied to, and that these embodiments are expressly contemplated as being within the scope of the present disclosure.

Continuing to step 708, the gaming system pulls random numbers from a random number generator (“RNG”). In one embodiment, the system pulls one random number for each reel. In another embodiment, the system pulls one random number which may be utilized to determine the stop positions for each reel. In another embodiment, the random numbers determined by the RNG may be based on the time that the numbers may be pulled. In another embodiment, the random numbers determined by the RNG may be based on the prior numbers pulled.

At steps 710 and 712, the gaming system utilizes the random numbers pulled at step 708 to determine the primary game symbols to display in the play of the primary game, which in turn both determines the presentation of the game to the player and evaluates the game outcome. In one embodiment, the random numbers pulled determine the stopping positions for the reels, which may be then caused to stop at those associated positions, and then the gaming system evaluates the displayed primary game symbols to determine the game outcome. In another embodiment, the gaming system determines the game outcome based on the pulled random numbers, and then causes the game to present an associated outcome to the player.

At step 714, the win or loss outcome may be identified for the player. In one embodiment, this step can include additional messaging, which provides information related to the win or loss, such as why the player won or lost. In another embodiment, this step can include identification of the amount of any award earned by the player.

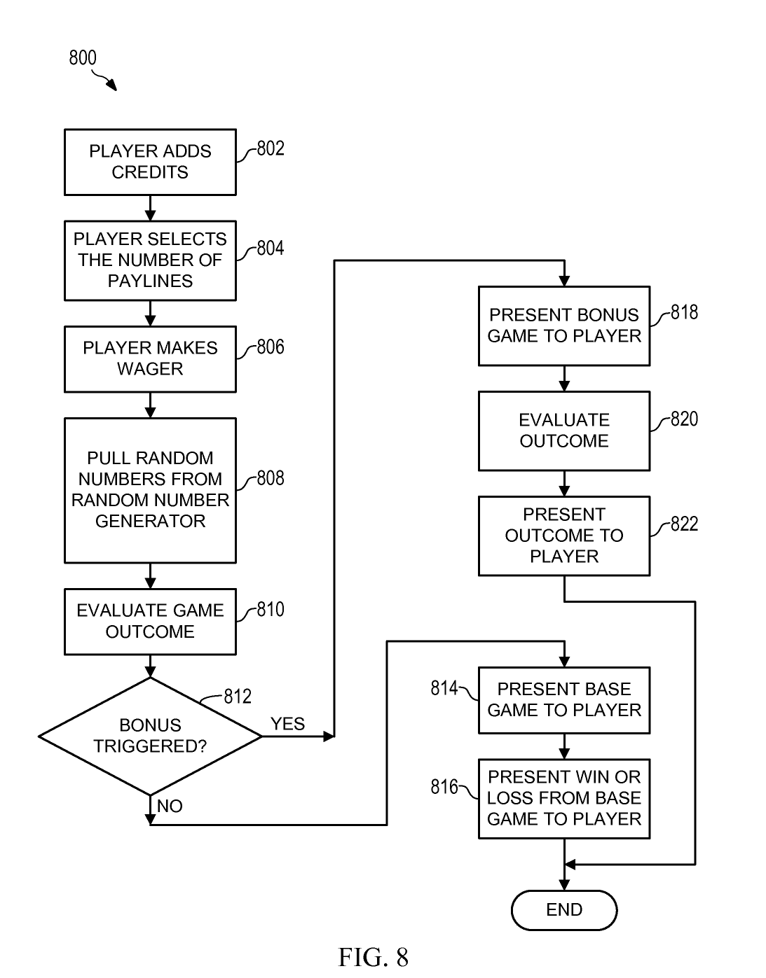

FIG. 8 is a process flowchart of one example of a combined primary and secondary game play 800 on an electronic gaming system, according to one embodiment. The method may include the step of a player adding credit to the electronic gaming system (step 802). It is contemplated that a player can do this by inserting cash, coins, a ticket representative of a cash value, a credit card, a player card, requesting an electronic funds transfer (“EFT”), otherwise requesting access to an account having monetary funds, and/or any combination thereof.

At step 804, the player selects the number of paylines to play. In one embodiment, the player can select from a plurality of different paylines to play. In a further embodiment, the player can only play a predetermined number of paylines. An example of this embodiment may be the instance where the gaming system only allows a player to play forty paylines, and cannot select to play more or less paylines. In another embodiment, the gaming system does not offer paylines, but rather offers a different way to evaluate the game play. One example of a different way may be sometime referred to as a 243-ways evaluation, where symbols may be evaluated based on the existence of like-symbol clusters on adjacent reels, starting with the left-most reel and continuing right, instead of how many paylines run through the like-symbol clusters.

At step 806, the player makes a wager on the game. In one embodiment, the wager may be a multiple of the number of paylines selected at step 804. In another embodiment, the wager may not be a multiple of the number of paylines selected at step 804. In a further embodiment, the wager may include a side-wager, which may, in one example of such an embodiment, be used to make the player eligible to be awarded the extra functionality discussed above. It should be appreciated that in some embodiments, the order of steps 804 and 806 may be not critical, and so for example, a player can select the wager they wish to place, and then select the number of paylines they want it applied to, and that these embodiments may be expressly contemplated as being within the scope of the present disclosure.

Continuing to step 808, the gaming system pulls random numbers from a random number generator “RNG”. In one embodiment, the system pulls one random number for each reel. In another embodiment, the system pulls one random number which may be utilized to determine the stop positions for each reel. In another embodiment, the random numbers determined by the RNG may be based on the time that the numbers may be pulled. In another embodiment, the random numbers determined by the RNG may be based on the prior numbers pulled.

At step 810, the gaming system utilizes the random numbers pulled at step 808 to evaluate the game outcome. In one embodiment, the random numbers pulled determine the stopping positions for the reels, which may be then caused to stop at those associated positions, and then the gaming system evaluates the displayed primary game symbols to determine the game outcome. In another embodiment, the gaming system determines the game outcome based on the pulled random numbers, and then causes the game to present an associated outcome to the player.

At step 812, the gaming system determines if a secondary or bonus game may be triggered. In one embodiment, the bonus game is triggered by the display of a plurality of matching symbols at a plurality of predetermined symbol positions within a play of the primary game. In one example, the bonus game may be triggered if a plurality of matching symbols is displayed on the 2^{nd}, 3^{rd} and 4^{th} reel. In another example, the bonus game may be triggered if matching symbols are displayed on the 1^{st}, 2^{nd} and 3^{rd} reels. In a further example, the bonus game may be triggered if matching symbols occur at predetermined symbol positions that include consecutive and non-consecutive reels. In another example, a bonus game (e.g., secondary game) may be triggered in any way (e.g., one special symbols in any locations, one special symbol in one or more predetermined locations, two special symbols in any locations, two special symbols in one or more predetermined locations, three special symbols in any locations, three special symbols in one or more predetermined locations, etc.).

If it is determined that a bonus or secondary game was not triggered, the process continues to step 814, where the base game may be fully presented to the player. As discussed above, the orders of step 810, 812, and 814 can be changed without affecting the novel concepts disclosed herein.

At step 816, the win or loss outcome of the primary game may be identified for the player. In one embodiment, this step can include additional messaging, which provides information related to the win or loss, such as why the player won or lost. In another embodiment, this step can include identification of the amount of any award earned by the player

If it is determined at step 812 that a bonus or secondary game was triggered, then process 800 continues to step 818, where the secondary game may be presented to the player. As discussed above, there are numerous ways to present the secondary or bonus game to the player.

At steps 820 and 822, the outcome of the secondary game may be evaluated and presented to the player. In one embodiment, the outcome of the bonus game will always be a winning outcome. In another embodiment, the outcome of the secondary game will cause a significant award to be provided to the player. In one example of such an embodiment, the award may not be provided by the gaming system, as a casino operator may need to verify tax information before allowing such an award to be provided to the player. In one embodiment, instead of the process 800 ending after step 822, the process continues to step 814 so as to finalize the primary game outcome presentation to the player.

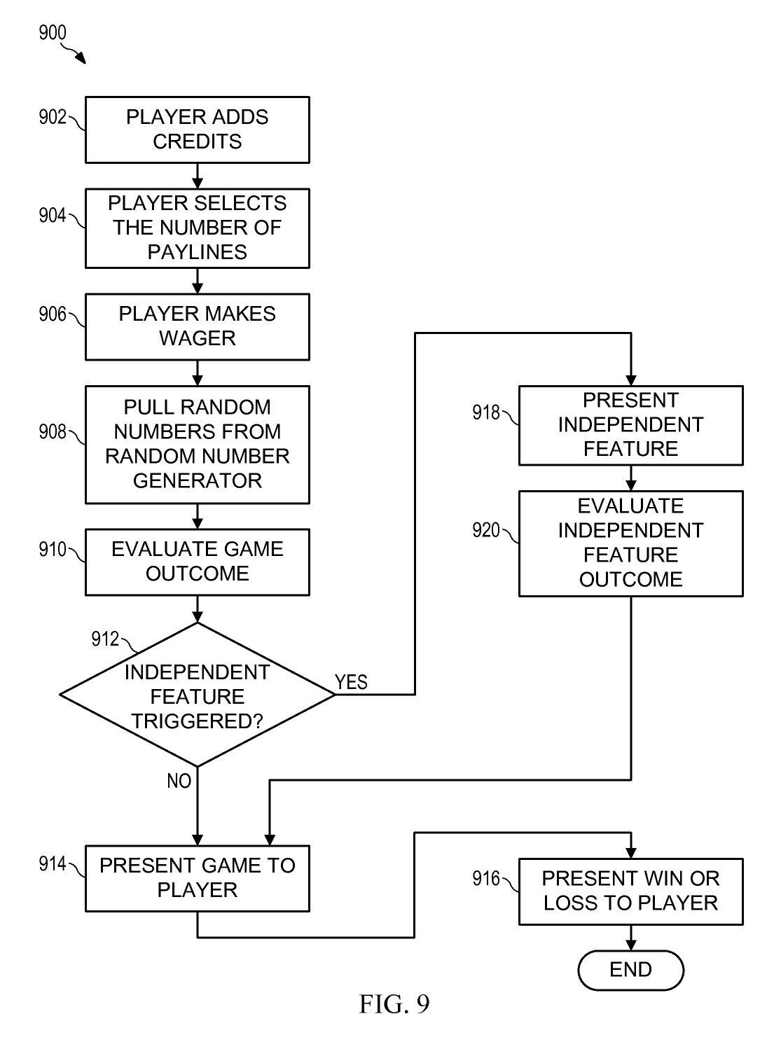

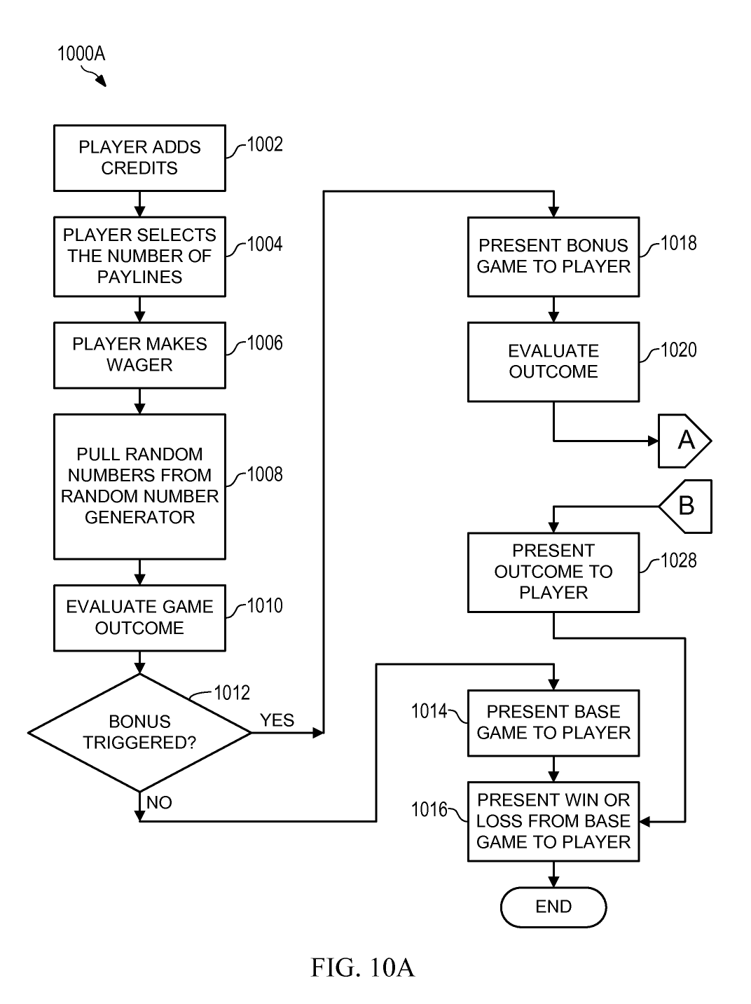

In FIG. 9, a flow diagram for game play 900 is shown, according to one embodiment. The method may include the player adding credits to electronic gaming device 100 (step 902). The method may include the player selecting the number of paylines to play (step 904). The method may include the player making a wager (step 906). The method may include a random number generator pulling one or more random numbers (step 908). The method may include one or more processors evaluating the game outcome (step 910). The method may include electronic gaming device 100 and/or electronic gaming system 200 determining whether an independent feature has been triggered (step 912). If no independent feature has been triggered, then the method may present the game to the player (step 914) and present a win or a loss to the player (step 916). If an independent feature has been triggered, then the method may present the independent feature (step 918). The method may then evaluate the independent feature outcome (step 920) and present this independent feature outcome to the player. The method may include then presenting the base and/or bonus game outcome to the player (step 914) and then present a win or a loss to the player (step 916).

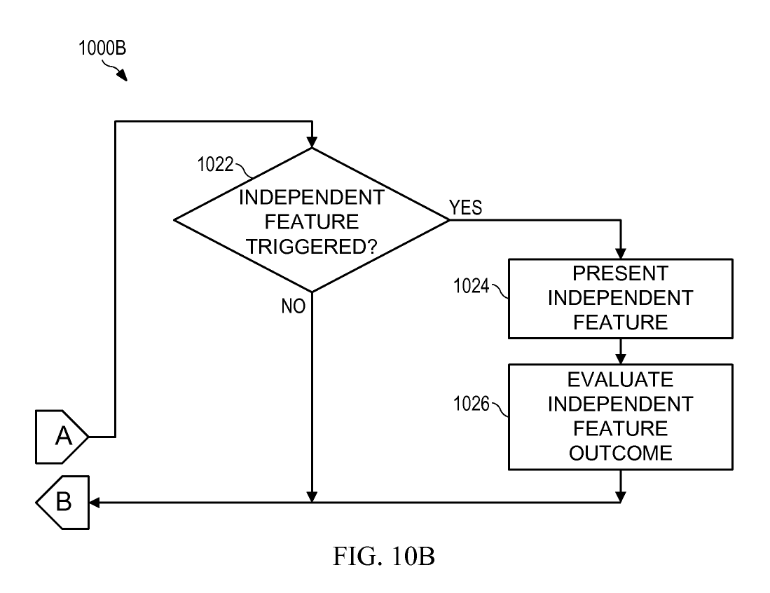

In FIG. 10A, a flow diagram for game play 1000A is shown, according to one embodiment. The method may include the player adding credits to electronic gaming device 100 (step 1002). The method may include the player selecting the number of paylines to play (step 1004). The method may include the player making a wager (step 1006). The method may include a random number generator pulling one or more random numbers (step 1008). The method may include one or more processors evaluating the game outcome (step 1010). The method may include electronic gaming device 100 and/or electronic gaming system 200 determining whether a bonus triggering event has occurred (step 1012). If no bonus triggering event has occurred, then the method may include presenting a base game to a player (step 1014) and presenting a win or a loss from the base game to the player (step 1016). If a bonus triggering event has occurred, then the method may include presenting the bonus game to the player (step 1018). The method may include evaluating the outcome of the bonus game (step 1012). The method may include electronic gaming device 100 and/or electronic gaming system 200 determining whether an independent feature has been triggered (step 1022) (see FIG. 10B). If no independent feature has been triggered, then the method may present the game to the player (step 1028) and present a win or a loss to the player (step 1016) (see FIG. 10A). If an independent feature has been triggered, then the method may present the independent feature (step 1024) (see FIG. 10B). The method may then evaluate the independent feature outcome (step 1026) and present this independent feature outcome to the player. The method may include then presenting the base and/or bonus game outcome to the player (step 1014) and then present a win or a loss to the player (step 1016) (see FIG. 10A).

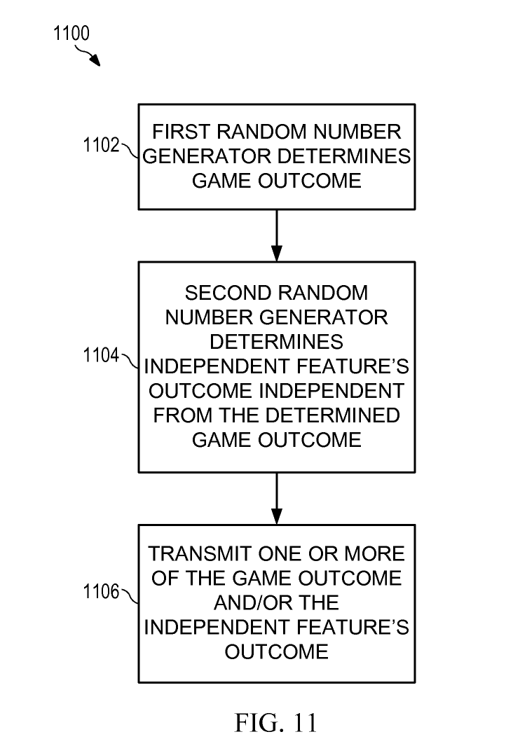

In FIG. 11, a flow diagram for game play 1100 is shown, according to one embodiment. The method may include that a first random number generator determines one or more game outcomes (step 1102). The method may include that a second random number generator determines one or more independent features' outcomes independent from the one or more game outcomes determined in step 1102 (step 1004). The method may transmit one or more of the game outcomes and/or the one or more independent features' outcomes (step 1106).

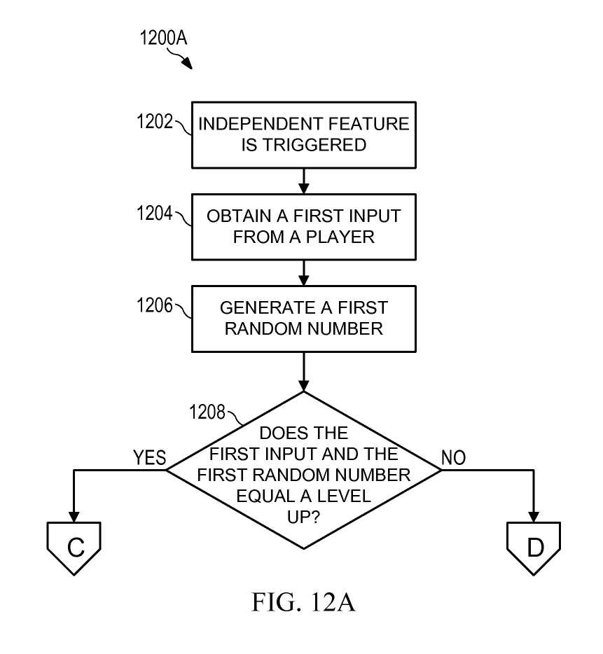

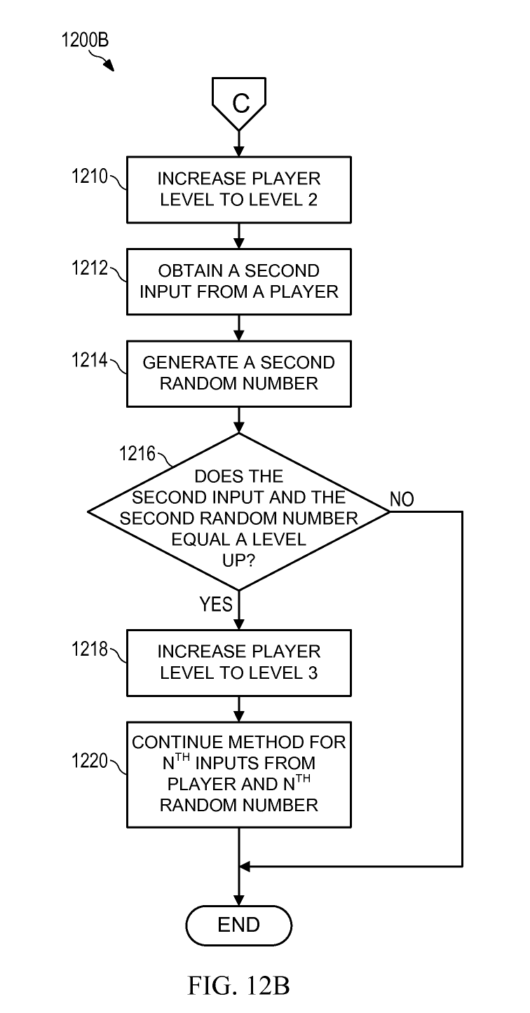

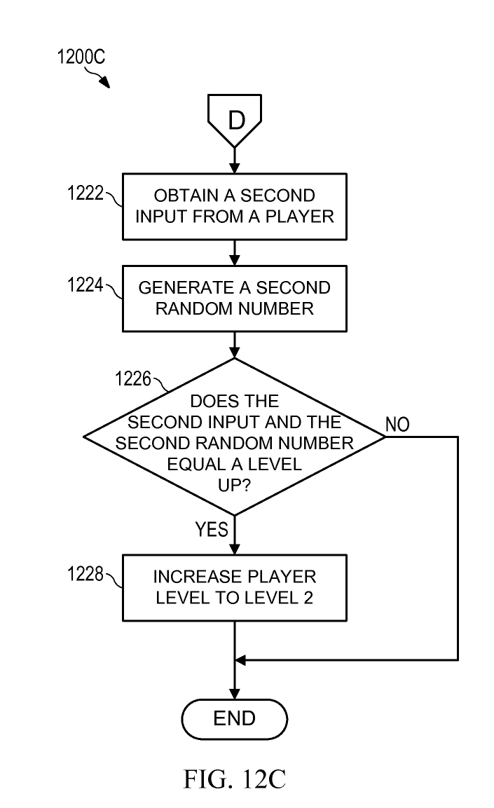

In FIG. 12A, a flow diagram for game play 1200A is shown, according to one embodiment. The method may include an independent feature being triggered (step 1202). The method may include obtaining a first input from a player (step 1204). The method may include generating a first random number (step 1206). The method may include that electronic gaming device 100 and/or electronic gaming system 200 determines whether the first input and the first random number equal a level up (step 1208). If the first input and the first random number do not equal a level up, then the method may include obtaining a second input from a player (step 1222) (see FIG. 12C). The method may include generating a second random number (step 1224). The method may include that electronic gaming device 100 and/or electronic gaming system 200 determines whether the second input and the second random number equal a level up (step 1226). If the second input and the second random number do not equal a level up, then the method may continue for Nth number of inputs and Nth number of random numbers in a similar manner until the method ends. If the second input and the second random number do equal a level up, then the method may increase a player level to level two (and/or any level—Level 3, Level 4, Level X, Level Y, etc.). The method may continue for Nth additional number of inputs and Nth additional number of random numbers.

Referring back to FIG. 12A, If the first input and the first random number do equal a level up, then the method may include increasing a player level to a level two (step 1210) (see FIG. 12B). The method may include obtaining a second input from a player (step 1212). The method may include generating a second random number (step 1214). The method may include that electronic gaming device 100 and/or electronic gaming system 200 determines whether the second input and the second random number equal a level up (step 1216). If the second input and the second random number do not equal a level up, then the method may continue for Nth number of inputs and Nth number of random numbers in a similar manner until the method ends. If the second input and the second random number do equal a level up, then the method may include increasing a player level to a level three (step 1218). The method may include continuing the method and evaluating the data based on Nth inputs from player and Nth random numbers from random number generator in a similar manner until the method ends. In one example, a player via a character (e.g., Dirk) may select an object (e.g., sword from a selection of a sword, an arrow, a hammer, etc.) for Dirk to utilize to fight with an enemy. If this is the correct decision, Dirk may live and the game level may be increased. If this is the wrong decision, Dirk may die and the game level may not be increased. In this example, the player via a character (e.g., Dirk) may have another option when another independent feature is triggered to select a path (e.g., a first path from a selection of a first path, a second path, etc.) for Dirk to utilize to avoid an obstacle. If this is the correct decision, Dirk may live and the game level may be increased. If this is the wrong decision, Dirk may die and the game level may not be increased.

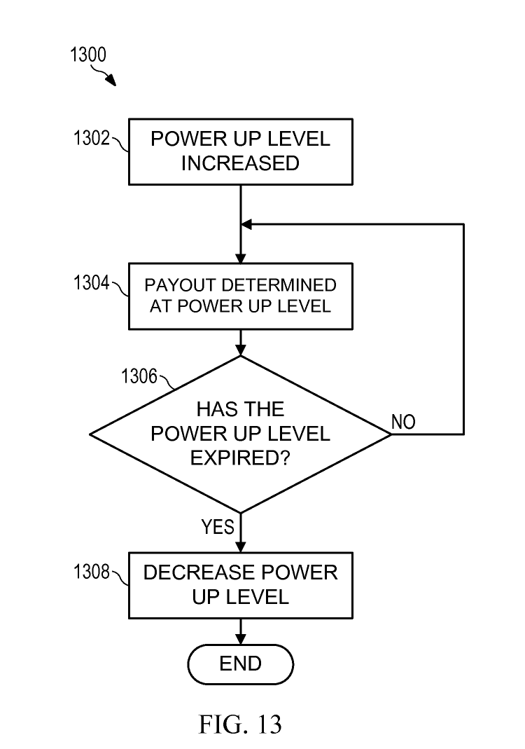

In FIG. 13, another game flow diagram 1300 is shown. The method may include increasing a power-up level (step 1302). The method may include determining a payout based on the power-up level (step 1304). The method may include electronic gaming device 100 and/or electronic gaming system 200 determining whether the power-up level has expired (step 1306). If the power-up level has not expired, then the method moves back to step 1304. If the power-up level has expired, then the method may include decreasing the power-up level (step 1308).

In one embodiment, the electronic gaming device may include a processor, a memory, and a plurality of reels. The plurality of reels may include one or more areas. The memory may include one or more independent features structures. The processor may generate one or more symbols to be located in the one or more areas. The processor may initiate at least a first independent feature structure based on an independent feature triggering event.

In another example, the processor may initiate a base game, a bonus game, and/or an independent feature game. In one example, the independent feature game outcome is independent of any base game outcome and bonus game outcome. In another example, the processor may utilize a first random number generating function for the base game outcome and the bonus game outcome. In an example, the processor may utilize a second random number generating function for the independent feature game outcome. In another example, the processor may suspend the base game and the bonus game based on an initiation of the independent feature game. In one example, the processor may restart the base game and the bonus game from one or more suspension points based on a completing of the independent feature game. In another example, the base game and the bonus game may be at one or more game levels. In an example, the processor may increase and/or decrease one or more game levels based on an independent feature game outcome.

In another embodiment, a method of providing game play via an electronic gaming device may include: initiating via one or more processors a base game; determining via the one or more processors that an independent feature game triggering event has occurred; and/or initiating via the one or more processors an independent feature game.

In one example, the independent feature game outcome is independent of a base game outcome. In another example, the method may further include utilizing a first random number generating function for the base game outcome. In an example, the method may further include utilizing a second random number generating function for the independent feature game outcome. In one example, the method may further include suspending at least one of the base game and a bonus game based on an initiation of the independent feature game. In another example, the method may further include restarting at least one of the base game and the bonus game from one or more suspension points based on a completing of the independent feature game. In an example, the base game is at one or more game levels.

In another embodiment, the electronic gaming system may include a display device with a plurality of reels (the plurality of reels including one or more areas) and a server, which includes a server processor and a server memory. The server memory may include one or more independent features structures. The server processor may generate one or more symbols to be located in the one or more areas. The server processor may initiate at least a first independent feature structure based on an independent feature triggering event.

In another example, the server processor may initiate a base game, a bonus game, and an independent feature game. In one example, the independent feature game outcome is independent of any base game outcome and bonus game outcome. In another example, the server processor may utilize a first random number generating function for the base game outcome and the bonus game outcome.

One or more sensors may obtain and/or transmit one or more data points (e.g., positional data, temperature data, etc.) relating to one or more audio devices, one or more display devices, audio interface area, audio support area, audio locking device, one or more electrical attachment devices, one or more attachment areas, electronic gaming device 100, electronic gaming system 200, first audio device, wall of the audio installation area, back of the audio installation area, one or more audio interfaces, one or more electrical attachment points, an input area, one or more input devices, second audio device, front-mounted audio device, audio interface locked area, one or more electrical interconnection points, one or more electrical wires, one or more springs, one or more motors, one or more adjustable devices, and/or one or more sensors to one or more processors.

One or more sensors may obtain and/or transmit one or more data points (e.g., positional data, temperature data, etc.) relating to one or more audio devices, one or more display devices, one or more electrical wires, one or more springs, one or more motors, one or more adjustable devices, and/or one or more sensors to one or more processors.

In one embodiment, the electronic gaming device may include a plurality of reels. The one or more paylines may be formed on at least a portion of the plurality of reels. The electronic gaming device may include a memory.

Gaming system may be a “state-based” system. A state-based system stores and maintains the system's current state in a non-volatile memory. Therefore, if a power failure or other malfunction occurs, the gaming system will return to the gaming system's state before the power failure or other malfunction occurred when the gaming system is powered up.

State-based gaming systems may have various functions (e.g., wagering, payline selections, reel selections, game play, bonus game play, evaluation of game play, game play result, steps of graphical representations, etc.) of the game. Each function may define a state. Further, the gaming system may store game histories, which may be utilized to reconstruct previous game plays.

A state-based system is different than a Personal Computer (“PC”) because a PC is not a state-based machine. A state-based system has different software and hardware design requirements as compared to a PC system.

The gaming system may include random number generators, authentication procedures, authentication keys, and operating system kernels. These devices, modules, software, and/or procedures may allow a gaming authority to track, verify, supervise, and manage the gaming system's codes and data.

A gaming system may include state-based software architecture, state-based supporting hardware, watchdog timers, voltage monitoring systems, trust memory, gaming system designed communication interfaces, and security monitoring.

For regulatory purposes, the gaming system may be designed to prevent the gaming system's owner from misusing (e.g., cheating) via the gaming system. The gaming system may be designed to be static and monolithic.

In one example, the instructions coded in the gaming system are non-changeable (e.g., static) and are approved by a gaming authority and installation of the codes are supervised by the gaming authority. Any change in the system may require approval from the gaming authority. Further, a gaming system may have a procedure/device to validate the code and prevent the code from being utilized if the code is invalid. The hardware and software configurations are designed to comply with the gaming authorities' requirements.

As used herein, the term “mobile device” refers to a device that may from time to time have a position that changes. Such changes in position may comprise of changes to direction, distance, and/or orientation. In particular examples, a mobile device may comprise of a cellular telephone, wireless communication device, user equipment, laptop computer, other personal communication system (“PCS”) device, personal digital assistant (“PDA”), personal audio device (“PAD”), portable navigational device, or other portable communication device. A mobile device may also comprise of a processor or computing platform adapted to perform functions controlled by machine-readable instructions.

The methods and/or methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” and/or “another example” should be considered to mean that the particular features, structures, or characteristics may be combined in one or more examples.

While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed.

1. An electronic gaming device comprising:
a plurality of reels, the plurality of reels including one or more areas;
a memory, the memory including one or more independent features structures;
a processor configured to generate one or more symbols to be located in the one or more areas, the processor configured to initiate at least a first independent feature structure based on an independent feature triggering event.

2. The electronic gaming device of claim 1, wherein the processor is further configured to initiate a base game, a bonus game, and an independent feature game.

3. The electronic gaming device of claim 2, wherein an independent feature game outcome is independent of any base game outcome and bonus game outcome.

4. The electronic gaming device of claim 3, wherein the processor is further configured to utilize a first random number generating function for the base game outcome and the bonus game outcome.

5. The electronic gaming device of claim 4, wherein the processor is further configured to utilize a second random number generating function for the independent feature game outcome.

6. The electronic gaming device of claim 2, wherein the processor is further configured to suspend the base game and the bonus game based on an initiation of the independent feature game.

7. The electronic gaming device of claim 6, wherein the processor is further configured to restart the base game and the bonus game from one or more suspension points based on a completing of the independent feature game.

8. The electronic gaming device of claim 2, wherein the base game and the bonus game are at one or more game levels.

9. The electronic gaming device of claim 8, wherein the processor is further configured to increase one or more game levels based on an independent feature game outcome.

10. A method of providing game play via an electronic gaming device comprising:
initiating via one or more processors a base game;
determining via the one or more processors that an independent feature game triggering event has occurred; and
initiating via the one or more processors an independent feature game.

11. The method of claim 10, wherein an independent feature game outcome is independent of a base game outcome.

12. The method of claim 10, further comprising utilizing a first random number generating function for the base game outcome.

13. The method of claim 12, further comprising utilizing a second random number generating function for the independent feature game outcome.

14. The method of claim 10, further comprising suspending at least one of the base game and a bonus game based on an initiation of the independent feature game.

15. The method of claim 14, further comprising restarting at least one of the base game and the bonus game from one or more suspension points based on a completing of the independent feature game.

16. The method of claim 10, wherein the base game is at one or more game levels.

17. An electronic gaming system comprising:
a server including a server processor and a server memory;
a display device including a plurality of reels, the plurality of reels including one or more areas;
the server memory including one or more independent features structures;
the server processor configured to generate one or more symbols to be located in the one or more areas, the server processor configured to initiate at least a first independent feature structure based on an independent feature triggering event.

18. The electronic gaming system of claim 17, wherein the server processor is further configured to initiate a base game, a bonus game, and an independent feature game.

19. The electronic gaming system of claim 18, wherein an independent feature game outcome is independent of any base game outcome and bonus game outcome.

20. The electronic gaming device of claim 19, wherein the server processor is further configured to utilize a first random number generating function for the base game outcome and the bonus game outcome.
